(19) United States
(12) Patent Application Publication
(10) Pub. No.: US 2008/0174234 A1
(43) Pub. Date: Jul. 24, 2008

(54) DISPLAY DEVICE AND SPACER FOR DISPLAY DEVICE

(76) Inventors: Hiroki Yamamoto, Hitachi (JP); Takashi Naito, Funabashi (JP); Yuichi Sawai, Miyazaki (JP); Osamu Shiono, Hitachi (JP); Motoyuki Miyata, Hitachinaka (JP); Hiroshi Ito, Chiba (JP); Akira Hatori, Chiba (JP); Nobuhiko Hosotani, Miyazaki (JP); Kyoto Honbo, Hitachinaka (JP); Fusao Hojo, Tokai (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/017,362

(22) Filed: Jan. 22, 2008

(30) Foreign Application Priority Data
Jan. 23, 2007 (JP) 2007-012442
Feb. 6, 2007 (JP) 2007-026641
Feb. 28, 2007 (JP) 2007-049164
Mar. 20, 2007 (JP) 2007-072491

(51) Int. Cl. H01J 1/62; H01J 1/88

(52) U.S. Cl. 313/498; 313/292

(57) ABSTRACT

The purpose of the present invention is to provide a spacer having a small absolute value of the temperature coefficient of resistance, the spacer being excellent in suppressing a thermal runaway, the spacer being excellent in voltage endurance so as not to cause an abnormal discharge even if a high voltage of over 10 kV is applied, the spacer being unlikely to cause deflection of an electron beam, and a flat panel display device provided with this spacer. The spacer of the flat panel display device includes, on the surface of a glass substrate, a thin film that comprises substances exhibiting metal-like electrical conductivity dispersed in an oxide matrix exhibiting semiconductor-like electrical conductivity. Alternatively, the spacer includes, on the surface of a glass substrate, a particle-dispersed oxide thin film that comprises substances exhibiting metal-like electrical conductivity dispersed in an oxide matrix, and the spacer further includes, on top of this film, an oxide thin film composed of an oxide exhibiting semiconductor-like electrical conductivity.

### FIELD OF THE INVENTION

The present invention relates to a flat panel display device and a spacer used therefor.

### BACKGROUND OF THE INVENTION

As information processing devices or television broadcasting move into high-definition in recent years, flat panel display devices (FPD: Flat Panel Display) are gaining increased attention because they have high brightness and high definition characteristics and also can achieve light weight and space saving. Typical flat panel display devices include a liquid crystal display device, a plasma display device, and also a field emission display (hereinafter, referred to as FED) that has received attention in recent years.

An FED is a self-luminous display device having an electron source, in which electron emission elements comprised of a cold cathode element are disposed in a matrix. As the electron emission element, a surface conduction type emission element (SED type), a field emission type element (FE type), a metal/insulating film/metal type emission element (MIM type), and the like are known. Moreover, as the FE type, a spinto type composed of a metal such as molybdenum or a semiconductor material such as silicon, a CNT type using a carbon nanotube as the electron source, and the like are known.

In an FED, a space needs to be provided between a cathode panel on the back side, in which an electron source is formed, and an anode panel on the front side, in which a fluorescent substance that emits light by being excited by electrons, the electrons being emitted from the electron source, is formed. This space needs to be kept under vacuum atmosphere. In order for the space portion kept in vacuum to be able to withstand atmospheric pressure, a supporting member called a spacer is usually disposed between the two panels.

In FED, usually, a voltage is applied to the anode so that the potential difference between the electron source and the anode may be on the order of several kV to several tens of kV. The higher this voltage, the higher brightness and longer life of the panel can be achieved, but the spacer is likely to be charged. If a spacer is charged, an electron beam flying from the cathode to the anode is attracted to a spacer side or repels to move away from a spacer. This results in a problem that the brightness changes and thus a shadow of a spacer is displayed on a screen to degrade the image quality. Moreover, an electric discharge is likely to occur and thus the cathode and other structural components are more likely to be destroyed.

In order to avoid such problems, a spacer comprising an insulating glass substrate and a thin film formed on the surface thereof, the thin film facilitating the conduction of electrons, is known. Here, as the thin film, an oxide cermet film containing a noble metal having a negative temperature coefficient of resistance is proposed (for example, see Patent Document 1). By forming on the surface of a spacer an oxide cermet film containing a noble metal, the so-called thermal runaway, in which temperature increase due to the power consumed on the surface of the spacer reduces the resistance and thereby an excessive current flows, can be suppressed.

### (Patent Document 1)

Japanese Patent No. 3745078 (Claims)

### BRIEF SUMMARY OF THE INVENTION

As described in Patent Document 1, a spacer including on the surface of a glass substrate an oxide cermet film containing a noble metal is effective in suppressing thermal runaway. However, there is apprehension that a high voltage of approximately 10 kV applied to between an anode substrate and a cathode substrate causes a current to flow only through the thin film on the surface of a spacer, and as a result, an abnormal discharge occurs in the spacer and thus the panel is likely to be destroyed. Moreover, since a matrix of this oxide cermet film is an insulator, the matrix portion may be charged to positive by electronic irradiation and thus the electrons emitted from an electron source in the vicinity of a spacer may be attracted by this charged portion to degrade the image quality.

It is an object of the present invention to provide a spacer having a small absolute value of the temperature coefficient of resistance, the spacer being excellent in suppressing thermal runaway, the spacer being excellent in voltage endurance so as not to cause an abnormal discharge even if a high voltage of over 10 kV is applied, the spacer being unlikely to cause deflection of an electron beam, and a flat panel display device provided with this spacer.

In order to solve the above problems, the present invention provides a flat panel display device comprising:

a cathode substrate including an electron source;

an anode substrate including a fluorescent substance which emits light upon receiving electrons emitted from the electron source; and

a spacer disposed between the cathode substrate and the anode substrate and supporting the both substrates,

wherein the spacer comprises, on a surface of a glass substrate, a thin film comprising particles exhibiting metal-like electrical conductivity dispersed in a metal oxide matrix exhibiting semiconductor-like electrical conductivity.

Moreover, the present invention provides a flat panel display device comprising:

a cathode substrate including an electron source;

an anode substrate including a fluorescent substance which emits light upon receiving electrons emitted from the electron source; and

a spacer disposed between the cathode substrate and the anode substrate and supporting the both substrates,

wherein the spacer comprises:

a glass substrate;

a first metal oxide thin film exhibiting a semiconductor-like electrical conductivity, the first metal oxide thin film being directly formed on a side surface of the glass substrate;

a second metal oxide thin film into which particles exhibiting metal-like electrical conductivity are dispersed, the second metal oxide thin film being formed on an outside of the first metal oxide thin film; and

a third metal oxide thin film exhibiting semiconductor-like electrical conductivity, the third metal oxide thin film being formed on an outside of the second metal oxide thin film.

Moreover, the present invention provides a flat panel display device comprising:

a cathode substrate including an electron source;

an anode substrate including a fluorescent substance which emits light upon receiving electrons emitted from the electron source; and

a spacer disposed between the cathode substrate and the anode substrate and supporting the both substrates,

wherein the spacer comprises a glass substrate and a thin film formed on a side surface thereof,

wherein the thin film comprises: particles exhibiting metal-like electrical conductivity; a metal oxide layer exhibiting an insulator-like electrical characteristic which covers surfaces of the particles; and

a composite metal oxide into which said particles are dispersed, and

wherein the composite metal oxide comprises a solid solution of a metal oxide having semiconductor-like electrical conductivity and a metal oxide having insulator-like electrical conductivity.

The substance exhibiting metal-like electrical conductivity comprises at least one type selected from the group consisting of Au, Pt, Ag, Cr, and Cu. Moreover, the metal oxide having semiconductor-like electrical conductivity is an oxide selected from the group consisting of Ga₂O₃, Cr₂O₃, Fe₂O₃, and a complex oxide of Fe₂O₃ and Ga₂O₃. It is preferable that elements forming the metal oxide having semiconductor-like electrical conductivity comprise iron and gallium, and contain, in terms of Fe₂O₃ and Ga₂O₃ oxides, from 20% to 80% by mol of Fe₂O₃ and from 80% to 20% by mol of Ga₂O₃. Moreover, it is further preferable that the thickness of the thin film is in the range from 20 nm to 200 nm.

Moreover, the present invention provides a flat panel display device comprising:

a cathode substrate including an electron source;

an anode substrate including a fluorescent substance which emits light upon receiving electrons emitted from the electron source; and

a spacer disposed between the cathode substrate and the anode substrate and supporting the both substrates,

wherein the spacer comprises a glass substrate and, on a surface of the glass substrate, an oxide thin film exhibiting metal-like electrical conductivity, and

wherein the oxide thin film is formed of a solid solution composed of an oxide exhibiting metal-like electrical conductivity and an oxide having a higher resistance than the former oxide.

The oxide exhibiting metal-like electrical conductivity is a ruthenium oxide, and the oxide having a higher resistance than the former oxide comprises at least one kind selected from the group consisting of a titanium oxide, an iridium oxide, a hafnium oxide, and a zirconium oxide. Moreover, the glass substrate of the flat panel display device of the present invention comprises an electronic conducting glass.

In the present invention, “exhibiting metal-like electrical conductivity” refers to a tendency for resistance to increase with an increase of temperature wherein the electrical conduction mechanism is based on electron conduction. Namely, because electron conduction occurs through free electrons in metal, with an increase of temperature the lattice vibration of a crystal lattice increases and thereby blocks the electron conduction, so that the mobility will decrease. Accordingly, with an increase of temperature the electric conductivity will decrease and the resistance will increase.

Moreover, “exhibiting semiconductor-like electrical conductivity” refers to a fact that the density of electrons (carriers) that are excited from the valence band to the conducting band increases exponentially with an increase of temperature and the resistance decreases with an increase of temperature.

Other objects, features and advantages of the invention will become apparent from the following description of the embodiments of the invention taken in conjunction with the accompanying drawings.

### BRIEF DESCRIPTION OF THE DRAWINGS

FIG. 1 is a cross sectional view of a spacer according to an example of the present invention.

FIG. 2 is a perspective view showing an external appearance of an MIM type FED.

FIG. 3 is a cross sectional view showing a portion along the A-A line of FIG. 2.

FIG. 4 is a schematic view of a cross section of a spacer including on the surface of a glass substrate a thin film exhibiting metallic conductivity.

FIG. 5 is a schematic view of a cross section of a spacer with a three layer structure thin film having an oxide thin film on both sides of a particle-dispersed oxide thin film.

FIG. 6 is a schematic view of a spacer cross section of a comparative example in which only a first metal oxide thin film is formed.

FIG. 7 is a schematic view of a spacer cross section of a comparative example in which only a second metal oxide thin film is formed.

FIG. 8 is a schematic view of a cross section of a spacer of a comparative example in which the second metal oxide thin film is formed after forming the first metal oxide thin film.

FIG. 9 is a schematic view of a cross section of a spacer of a comparative example in which a third metal oxide thin film is formed after forming the second metal oxide thin film.

FIG. 10 is a schematic view of a cross section of a thin film comprising metal particles dispersed in an oxide matrix.

FIG. 11 is a perspective view of a spacer prepared for evaluating the temperature dependence of the electrical resistance of a thin film.

FIG. 12 is a view showing the temperature change of volume resistivity for Au—Fe₂O₃—Ga₂O₃ thin films and a glass substrate.

FIG. 13 is a view showing the temperature change of temperature coefficient of resistance for an Au—Fe₂O₃—Ga₂O₃ thin film and a glass substrate.

FIG. 14 is a view showing the temperature change of volume resistivity for an electronic conducting glass substrate and a metal conductive thin film.

FIG. 15 is a graph showing a dielectric breakdown voltage with respect to a ratio between the resistance of a glass substrate and the resistance of a thin film.

FIG. 16 is an equivalent circuit schematic for calculating the resistance of a thin film.

FIG. 17 shows characteristic comparison between examples and comparative examples.

FIG. 18 is a schematic view showing the composition of a thin film formed on a side surface of a spacer glass substrate.

FIG. 19 is a perspective view of a spacer prepared for evaluating the temperature dependence of electrical resistance of a thin film.

FIG. 20 is a view showing the temperature change of volume resistivity of a spacer.

FIG. 21 is a view showing the temperature change of the temperature coefficient of resistance of a spacer.

### DESCRIPTION OF REFERENCE NUMERALS

110 . . . spacer, 114 . . . adhering frit, 115 . . . adhering frit, 210 . . . front panel, 211 . . . anode substrate, 212 . . . black matrix, 213 . . . phosphor layer, 220 . . . back panel, 221 . . . cathode substrate, 222 . . . electrode, 223 . . . electron source, 230 . . . sealing frame, 240 . . . display area, 401 . . . glass substrate, 403 . . . spacer end face metal film, 410 . . . metal conductive thin film, 420 . . . particle-dispersed oxide thin film, 421 . . . Au particle, 422 . . . SiO₂ matrix, 430 . . . particle-dispersed oxide thin film.

### DETAILED DESCRIPTION OF THE INVENTION

A flat panel display device of the present invention is characterized by a spacer.

A first spacer includes, on the surface of a glass substrate, a thin film that comprises substances exhibiting metal-like electrical conductivity dispersed in an oxide matrix exhibiting semiconductor-like electrical conductivity. In the first spacer, a resistance Rf of the thin film preferably has, with respect to a resistance Rs of the glass substrate, a relationship of 0.01 Rs≦Rf≦Rs. Moreover, the substance exhibiting metal-like electrical conductivity preferably comprises at least one type selected from a group consisting of Au, Pt, Ag, Cr, and Cu. The oxide matrix preferably comprises at least one kind selected from a group consisting of Ga₂O₃, Fe₂O₃ and Cr₂O₃. It is also preferable to constitute the oxide matrix with a mixture or a complex oxide of Fe₂O₃ and Ga₂O₃. The thickness of the thin film is preferably in the range from 20 nm to 200 nm.

A second spacer includes, on the side surface of a glass substrate, a first metal oxide thin film exhibiting semiconductor-like electrical conductivity, a second metal oxide thin film exhibiting metal-like conductivity, and a third metal oxide thin film exhibiting semiconductor-like electrical conductivity, in this order from the glass substrate side.

A third spacer comprises a glass substrate and a thin film formed on the side surface thereof, wherein the thin film comprises a particle exhibiting metallic conductivity, a metal oxide layer having an insulator-like electrical characteristic which covers the surface of the particle, and a composite metal oxide in which these are dispersed, and wherein the composite metal oxide is composed of a solid solution of a metal oxide having semiconductor-like electrical conductivity and a metal oxide having insulator-like electrical conductivity.

A fourth spacer is characterized by a spacer used for an image display device of the present invention, and the fourth spacer includes, on the surface of a glass substrate, an oxide thin film formed of a solid solution composed of an oxide exhibiting metal-like electrical conductivity and an oxide having a higher resistance than the former oxide. When the oxide exhibiting metal-like electrical conductivity is denoted by AO_{Y} and the oxide having a higher resistance than the former oxide is denoted by BOₓ, the both preferably form a solid solution composed of AₓB₍₁₋ₓ₎O_{y}.

Moreover, in the oxide thin film formed on the spacer surface, the valence of a metallic element constituting the oxide exhibiting metal-like electrical conductivity and the valence of a metallic element constituting the oxide having a higher resistance than the former oxide are preferably equal. Furthermore, when the ionic radius of a metallic element constituting the oxide exhibiting metal-like electrical conductivity is denoted by RA, and the ionic radius of a metallic element constituting the oxide having a higher resistance than the former oxide is denoted by R_{B}, it is preferable to have a relationship of 0.88<R_{A}/R_{B}≦1.33R_{B}.

In the fourth spacer, it is preferable that the oxide exhibiting metal-like electrical conductivity comprises a ruthenium oxide (RuO₂), and that the high-resistance oxide comprise at least one kind selected from a group consisting of a titanium oxide (TiO₂), an iridium oxide (IrO₂), a hafnium oxide (HfO₂), and a zirconium oxide (ZrO₂).

In the above-described first to fourth spacers, it is preferable that the thin film formed is covered using any one of a sputtering method, a spray method, a spin coat method, and a dip method. Furthermore, the glass substrate used is preferably a glass having electronic conductivity (in particular, a V—W—Mo—P—Ba—O based electronic conducting glass containing V, W, Mo, P, or Ba), but the glass substrate used is not limited thereto.

The material of a particle exhibiting metallic conductivity is not limited in particular as long as it exhibits metallic conductivity, however, at least one kind of metallic element selected from a group consisting of Au, Pt, and Ag is preferable in terms of oxidation stability by calcination and the like. Preferably, the average particle diameter of the particles is equal to or larger than 0.5 nm and is smaller than the film thickness of the composite metal oxide thin film. It is preferable that the proportion of particles to be dispersed exhibiting metallic conductivity is equal to or higher than 0.1% in the case of Au particles, for example, and that the particles are dispersed in such a content that the surface resistance of the thin film composed of a composite metal oxide may range from 1×10¹⁰ Ω/square to 1×10¹³ Ω/square. If the above-described proportion of particles is less than 0.1%, the resistance temperature characteristic will not be improved sufficiently. If the surface resistance is small, power consumption will increase and a risk of thermal runaway is likely to occur.

The material of the metal oxide layer having an insulator-like electrical characteristic formed on the surface of a particle exhibiting metallic conductivity is preferably selected from a group consisting of SiO₂, Al₂O₃, and Ta₂O₅. In particular, SiO₂ is preferable. Preferably, a sum of the thickness of the particle diameter of the particle exhibiting metallic conductivity and the thickness of the metal oxide layer does not exceed the film thickness of the composite metal oxide. Furthermore, the thickness of the metal oxide layer having an insulator-like electrical characteristic formed on the surface of the particle exhibiting metallic conductivity is preferably equal to or larger than 0.5 mm. If the thickness of the metal oxide layer is smaller than 0.5 mm, it is difficult to suppress particle growth of a metal particle.

The composite metal oxide comprises a solid solution of a metal oxide having semiconductor-like electrical conductivity, such as Fe₂O₃, and a metal oxide having insulator-like electrical conductivity, such as Ga₂O₃. More preferably, the radius ratio of these ions is such a value close to 1 as to be able to form a solid solution. The elements forming the composite metal oxide preferably comprise one kind selected from a group consisting of iron, chromium, manganese, nickel, vanadium, rhodium, molybdenum, and ruthenium, and one kind selected from a group consisting of aluminum and gallium. More preferably, the elements forming the composite metal oxide comprise iron and gallium, and contains, in terms of oxides, from 20% to 80% by mol of Fe₂O₃ and from 80% to 20% by mol of Ga₂O₃.

The surface resistance of a thin film composed of a composite metal oxide is preferably in the range from 1×10¹⁰ Ω/square to 1×10¹³ Ω/square. The film thickness of the thin film composed of a composite metal oxide is preferably in the range from 10 nm to 200 nm. If the film thickness is smaller than 10 nm, suppression of volatilization of a glass composition tends to be insufficient, resulting in potential degradation of emission. Also in this case, the resistance variation with temperature is large, so that it is difficult to obtain a spacer achieving an excellent deflection amount. If the film thickness exceeds 200 nm, this thick film thickness may cause unevenness in film due to film peeling or the like caused by a stress between a thin film and a glass substrate, and also the resistance of the spacer will decrease.

A spacer of the present invention can be manufactured as follows. Particles exhibiting metallic conductivity, the particles being covered with a metal oxide, are dispersed in a solution containing a precursor of a composite metal oxide to form a coating liquid. Then, this coating liquid is applied to the side surface of a glass substrate and the resultant glass substrate is calcined to thereby manufacture the spacer.

Here, the composite metal oxide precursor means a substance that can form a composite metal oxide by calcination after forming a film. As the composite metal oxide precursor, for example, a solution, coating material, or the like of a metal complex or metal alkoxide, such as an acetate or acetylacetonato of iron, chromium, manganese, nickel, vanadium, rhodium, molybdenum, ruthenium, aluminum, or gallium, can be used.

For the particle dispersed in the composite metal oxide precursor, for example, a particle can be used that is obtained by forming a metal oxide layer on the surface of a metal particle by a condensation reaction of a compound such as a metal alkoxide, the metal particle being formed by a reduction reaction or the like of a metal salt.

Hereinafter, a case where a spacer of the present invention is applied to an MIM type FED will be described, but the present invention is not limited to the MIM type.

### EXAMPLE 1

First, a first spacer is described in detail.

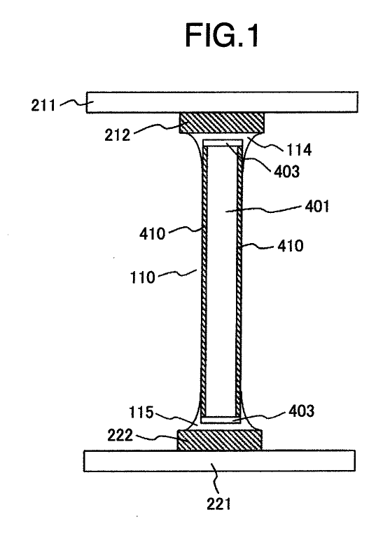

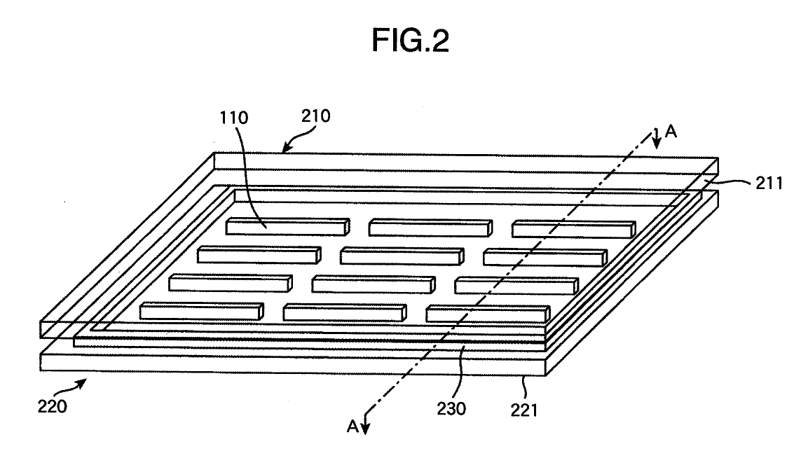

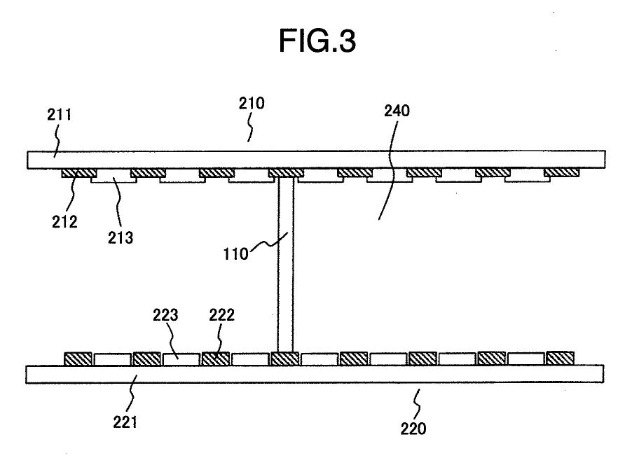

FIG. 1 shows a schematic view of a cross section of the first spacer concerning the present invention. FIG. 2 shows a perspective view of an MIM type FED, and FIG. 3 shows a portion of the cross section along the A-A line in FIG. 2.

In the MIM type FED, a front panel 210 includes a black matrix 212, i.e., a light shielding film, and a phosphor layer 213 on an inner surface side of an anode substrate 211, which is a substrate of a panel. Moreover, a back panel 220 includes an electrode 222 and an electron source 223, i.e., an emitter, on an inner surface side of a cathode substrate 221, which is a substrate of the panel.

A large number of spacers 110 are disposed between the black matrix 212 formed in the front panel 210 and the electrode 222 formed in the back panel 220. These spacers are adhered to the front panel via an adhering frit 114 and adhered to the back panel via an adhering frit 115. For the adhering frit, an electrically conductive one is used because a minute electric current flows through the spacer. In addition, in this example, a spacer end face metal film 403 is formed to facilitate a minute electric current to flow from the spacer to the substrate side.

A sealing frame 230 is provided in the inner peripheral edges of the anode substrate 211 and cathode substrate 221. This sealing frame 230 is adhered to the anode substrate and to the cathode substrate with an adhesive to thereby form a space portion between the back panel and the front panel. This space portion serves as a display region 240. The distance between the front panel and the back panel is typically about 3 mm to 5 mm, and the space portion is usually kept under vacuum atmosphere at a pressure of 10⁻⁵ to 10⁻⁷ Torr.

In the FED constructed in this manner, if an acceleration voltage on the order of several kV to several tens of kV is applied to between the back panel 220 and the front panel 210, electrons are emitted from the electron source, i.e., an emitter, and are collided with the phosphor layer 213 by the acceleration voltage, whereby the electrons excite the phosphor layer 213 to emit light of a predetermined frequency to the outside of the front panel 210. In this way, an image is displayed.

The spacer 110 includes, on the surface of the glass substrate 401, a thin film that comprises substances exhibiting metal-like electrical conductivity dispersed in an oxide matrix exhibiting semiconductor-like electrical conductivity. Or, the spacer 110 includes, on the surface of the glass substrate, a particle-dispersed oxide thin film comprising substances exhibiting metal-like electrical conductivity dispersed in an oxide matrix, and an oxide thin film composed of an oxide exhibiting semiconductor-like electrical conductivity.

The spacer is irradiated with electrons emitted from an electron source, i.e., an emitter, and the reflection electrons and secondary electrons from the anode and other constituting members. For this reason, the thin film formed on the surface of the spacer is required to have a low resistance so as to suppress charging due to the electrons to be emitted and so as not to bend the trajectory of an electron beam. However, if the resistance is too low, the consumption of a current flowing due to a voltage applied between the anode substrate and the cathode substrate increases and also thermal runaway is likely to occur. It is therefore necessary to adjust the resistance to an appropriate value. Taking into account these, the surface resistance of the spacer is preferably set within the range from 1×10¹⁰ Ω/square to 1×10¹³ Ω/square.

Here, the thermal runaway is a phenomenon in which a spacer is heated to a high temperature due to a current flowing between an anode substrate and a cathode substrate and thereby the resistance of the spacer itself decreases and a further larger current flows to increase the temperature, and as a result, the resistance further decreases, and by repeating this cycle, the spacer becomes hooter than its own softening temperature to blow out.

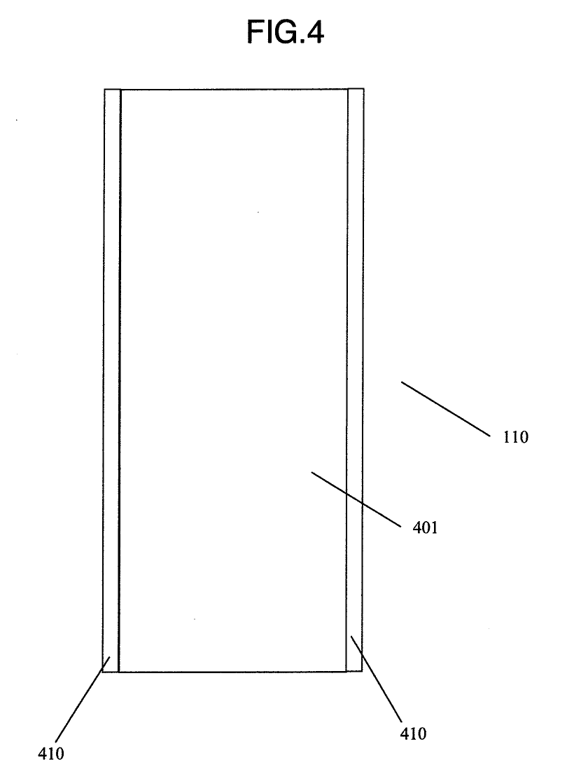

FIG. 4 shows a schematic view of the cross section of the first spacer concerning the present invention. The spacer 110 includes, on the surface of the glass substrate 401, a metal conductive thin film 410 comprising substances exhibiting metal-like electrical conductivity dispersed in an oxide matrix exhibiting semiconductor-like electrical conductivity. Use of an electronic conducting glass in the glass substrate 401 allows a current to flow also through the substrate, so that the withstand voltage can be increase and thus a bright image quality can be obtained. As the material of the glass substrate, a V—W—Mo—P—Ba—O based electronic conducting glass is preferable.

A substance having metal-like electrical conductivity has a property that the resistance increases as temperature increase, while a substance having semiconductor-like electrical conductivity has a property that the resistance decreases as temperature increase.

As the deposition method of a thin film other than a sputtering method, a coating and baking method via a solution, such as a spray method, a dip method, a sol-gel method, a dice method, and a spin coat method may be used.

The deposition method by sputtering is described taking a case where one layer of particle-dispersed oxide thin film composed of Au and 50Fe₂O₃-50Ga₂O₃ (mole ratio) is formed, as an example.

A chip of Au of 10 mm square is mounted on an erosion area of a 50Fe₂O₃-50Ga₂O₃ target of 152.4 mm φ×5 mm t so as to obtain a desired film composition, and then the deposition was performed. As the forming gas, a high purity Ar gas (99.9999%) was used. As the power supply, an rf magnetron power supply was used to apply a high voltage of approximately 700 W to the target. The vacuum pressure inside a deposition chamber before deposition was set to 4.0×10⁵ Pa.

In order to analyze the composition after deposition, a film was formed in the thickness of approximately 200 nm on a polyimide film, and the composition analysis was conducted using ICP spectroscopy. In Table 1 described below, the results of the composition analysis conducted in this manner are described as the film composition in mol %.

A film material composed of Au and 50Fe₂O₃-50Ga₂O₃ was formed in the thickness of 50 nm on a V—W—Mo—P—Ba—O base electronic conducting glass substrate under the above-described sputtering condition. The size of the glass substrate was set to 110 mm×3 mm×0.15 mm, where deposition was carried out on a portion of 110 mm×3 mm. Since the sputtering rate of a film varies depending on the composition thereof, the deposition was carried out calculating the rate for each composition. After completion of the deposition on one side, the sample was taken out to the atmosphere once, and the deposition on the rear surface was carried out after the upper and lower sides are reversed. In this manner, the deposition under the same condition was carried out to the both sides of the spacer.

Moreover, after completion of the deposition, Cr was formed in the thickness of approximately 100 nm as the spacer end face metal film on the both end faces (110×0.15 mm portion) of the spacer, the both end faces serving as a joint portion with the anode substrate and with the cathode substrate, respectively.

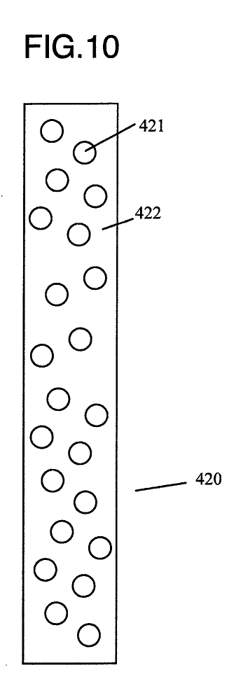

FIG. 10 shows a schematic view of a cross-sectional nano structure when a cross section of a prepared particle-dispersed oxide thin film 420 composed of Au and 50Fe₂O₃-50Ga₂O₃ is observed with a transmission electron microscope. As the transmission electron microscope, a transmission electron microscope HF-2000 manufactured by Hitachi, Ltd. was used. The acceleration voltage was set to 200 kV. Moreover, an FIB method (Focused Ion Beam method) was used in preparing samples. It was confirmed that an added Au particle 421 is dispersed in a 50Fe₂O₃-50Ga₂O₃ matrix 422, as a nano particle. Moreover, the particle diameter of an Au nano particle was approximately 10 nm.

With the above-described deposition method using sputtering, thin films of the composition shown in the Table 1 described below were formed on a glass substrate, respectively. A similar nano particle was observed also when Pt, Ag, Cr, or Cu was used as a metal particle or when SiO₂, Al₂O₃, Ta₂O₅, Ga₂O₃, Fe₂O₃, or the like was used as an oxide matrix.

The electrical conduction of a particle-dispersed oxide thin film that comprises metal particles dispersed in an oxide may be governed by the metallic conduction in metal nano particles and the conduction of the oxide matrix layer. When a material, such as SiO₂, Al₂O₃, or Ta₂O₅, having resistivity as high as 10¹⁴ Ωcm is used as the oxide matrix, hopping conduction may occur in particles. Moreover, when the resistance of the oxide matrix layer is semiconductive, electrical conduction may be carried out through a conduction mechanism such as hopping conduction in this matrix.

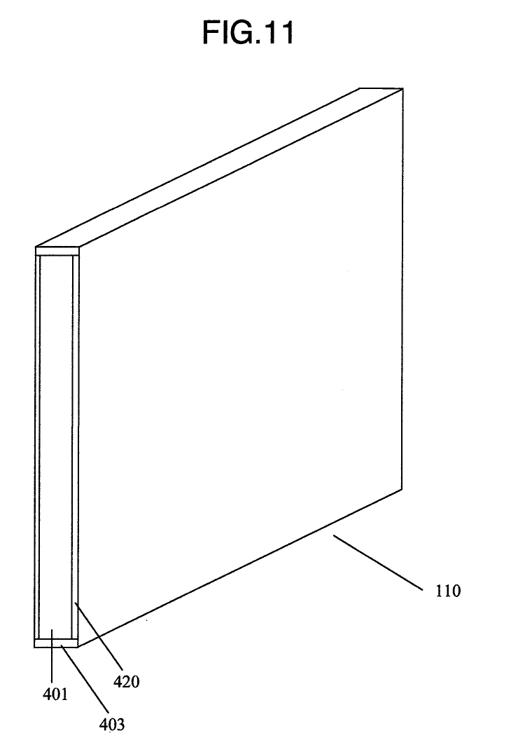

For a spacer having a thin film formed on a glass substrate, the thin film comprising Au nano particles dispersed in a 50Fe₂O₃-50Ga₂O₃ matrix, the temperature dependence of electrical resistance of the thin film was evaluated. FIG. 11 shows a perspective view of a spacer sample used for this evaluation.

For the spacer sample, a V—W—Mo—P—Ba—O based electronic conducting glass was used as the glass substrate 401, and on the side surface thereof, the particle-dispersed oxide thin film 420 exhibiting metallic conductivity composed of 50 mol % of Au nano particles and 50 mol % of 50Fe₂O₃-50Ga₂O₃ was formed in the thickness of 20 nm, 50 nm, and 100 nm, respectively. Moreover, as an electrode at the end face part of the spacer, a spacer end face metal film 403 composed of a 100 nm thick chromium metal was formed. A high voltage of approximately 500 V was applied to between these electrodes to measure the volume resistivity. The size of a sample was 3 mm in height, 0.110 mm in width, and 10 mm in length. This sample was pinched between high voltage electrodes, and the whole of these was held in a temperature controlled bath capable of being heated to 125° C., and while varying the temperature, the volume resistance at each temperature was measured. For the measurement, a sample was heated to 125° C. first and thereafter the resistance was measured during temperature fall.

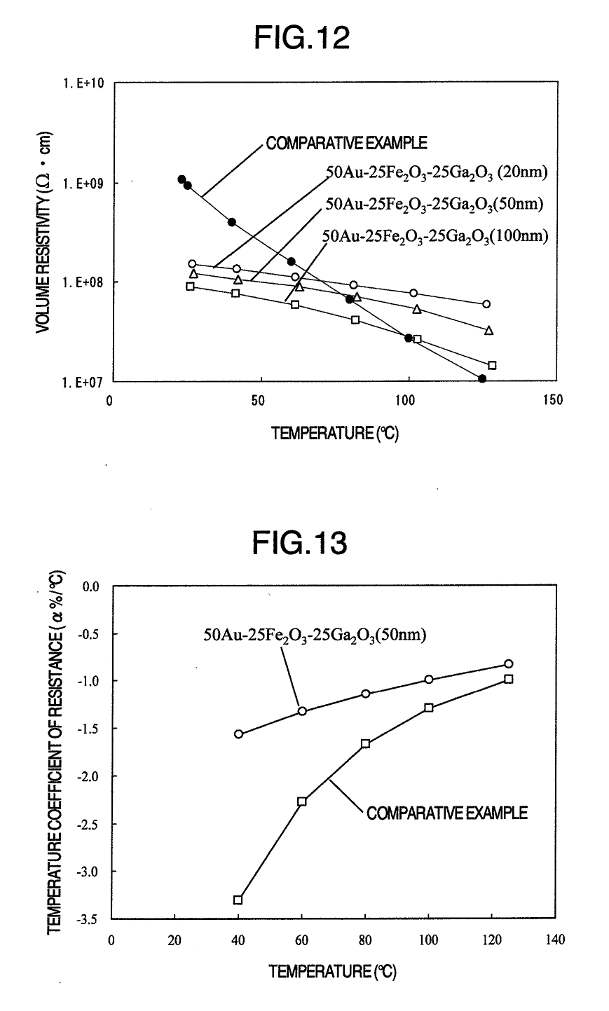

FIG. 12 shows the measured temperature change of the volume resistivity of samples. FIG. 12 also shows the temperature change of the volume resistivity of a glass substrate itself without a thin film. In the view, a thin film composed of 50 mol % of Au nano particles and 50 mol % of 50Fe₂O₃-50Ga₂O₃ is denoted by a 50Au-25Fe₂O₃-25Ga₂O₃ thin film. It can be seen that for the samples on which a metal conductive thin film was formed, the temperature change in the volume resistance is small and almost constant around room temperature. On the other hand, for the sample having only a glass substrate on which a thin film is not formed, the temperature change in resistance was extremely large to around room temperature.

FIG. 13 shows the temperature change of the temperature coefficient of resistance (α (%/° C.)) of a thin film for a sample in which a 50Au-25Fe₂O₃-25Ga₂O₃ thin film was formed in the thickness of 50 nm. In FIG. 13, the temperature coefficient of resistance was calculated using Equation 1.

$$α = \frac{R / {R}_{0} - 1}{T - {T}_{0}} \qquad ( Equation 1 )$$

In Equation 1, R denotes the volume resistivity at temperature T, and R₀ denotes the volume resistivity at room temperature (T₀). In this measurement, the room temperature T₀ was set to 25° C. While the temperature coefficient of resistance from 25° C. to 40° C. of a glass substrate itself was approximately −3.3%/° C., the temperature coefficient of resistance of the 50Au-25Fe₂O₃-25Ga₂O₃ thin film was as small as −1.57%/° C., thus providing a significant improvement.

However, the temperature coefficients of the resistance of either sample around 125° C. was approximately −1.0%/° C. It was found that if the absolute value of this temperature coefficient of resistance is within 3.0%/° C., the variation of the amount of beam deflection when temperature changes by 1° C. is equal to or less than 1 μm. In this case, when the temperature difference between an anode and a cathode is equal to or higher than 20° C., the amount of beam deflection exceeds 20 μm and therefore a shadow of the spacer can be seen on a screen. However, if the absolute value of the temperature coefficient of resistance is equal to or less than 3.0%/° C., the amount of beam deflection is equal to or less than 20 μm even when the temperature difference between the anode and the cathode is 20° C., which is therefore preferable.

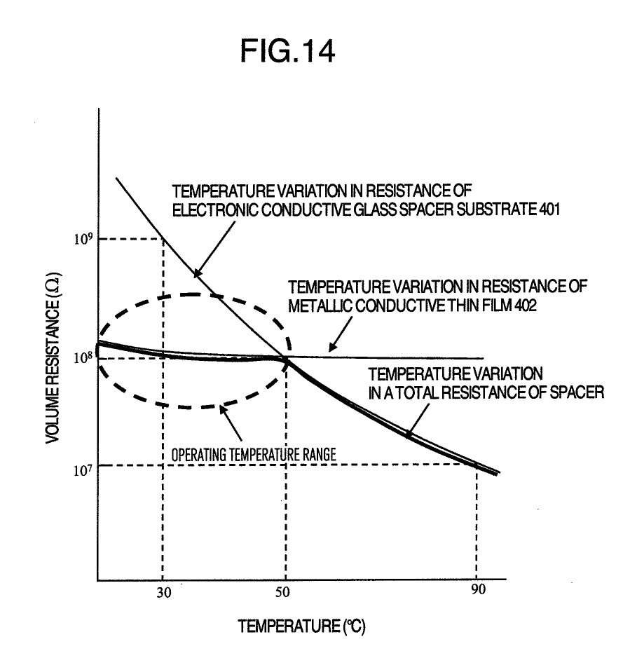

A mechanism for improving the temperature coefficient of resistance when a metal conductive thin film composed of Au—SiO₂ is formed is described using FIG. 14. FIG. 14 shows the temperature change of the volume resistivity for a glass substrate composed of an electronic conducting glass and a metal conductive thin film, respectively. It can be seen that the volume resistivity of the electronic conducting glass substrate varies by approximately two digits from room temperature to 90° C., while the volume resistivity of the thin film exhibiting metallic conductivity hardly varies around room temperature.

Now, assuming that the volume resistivity of the electronic conducting glass substrate at room temperature is 10⁹ Ωcm and that the volume resistivity of the metal conductive thin film is 10⁸ Ωcm, then the volume resistivity of the whole spacer is equal to the volume resistivity of the metal conductive thin film because the resistance is determined substantially by the lower volume resistivity. Accordingly, the volume resistivity of the whole spacer is almost equal to that of the metal conductive thin film until the temperature reaches a temperature at which the volume resistivity of the electronic conducting glass substrate becomes equal to the volume resistivity of the metal conductive thin film.

Accordingly, an extremely low temperature coefficient of resistance can be obtained around room temperature. On the other hand, as temperature increases and the volume resistivity of the electronic conducting glass falls below the volume resistivity of the metal conductive thin film, the volume resistivity of the whole spacer will be close to the volume resistivity of the electronic conducting glass substrate. The temperature coefficient of resistance may thus increase.

From above, in order to use an excellent temperature change in resistance of a thin film as the temperature change in the whole spacer resistance, the electrical resistance of the thin film needs to be equal to or less than the resistance of the spacer substrate in the operating temperature range of the panel. Namely, if the electrical resistance of a thin film is denoted by Rf and the electrical resistance of the spacer substrate by Rs, a relationship of Rf≦Rs is preferably satisfied.

On the other hand, if the electrical resistance Rf of the thin film is reduced, there is an advantage in that the temperature change in resistance can be reduced. However, if the resistance is made too small as compared with the resistance Rs of the substrate, a current flowing inside the spacer may concentrate on the thin film due to a voltage applied to the spacer and thus may destroy the thin film and cause dielectric breakdown. Then, the dielectric breakdown voltage was plotted with respect to the resistance Rf of the thin film to determine an optimum resistance.

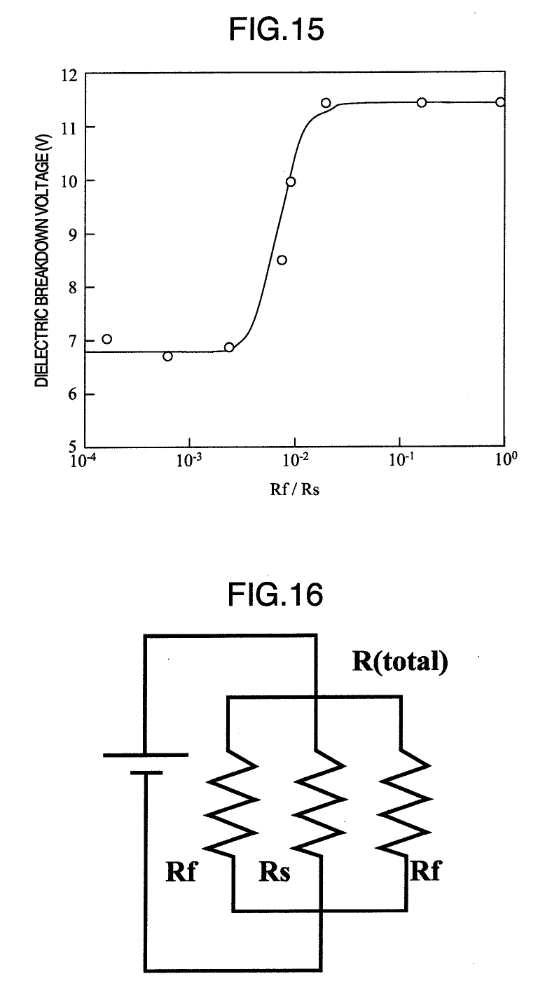

FIG. 15 shows a graph in which the dielectric breakdown voltage with respect to the ratio between the resistance Rf of a thin film and the resistance Rs of a substrate was plotted. In this measurement, thin films having different resistances were prepared by adjusting the amount of Au contained in the thin film, the film thickness, and the like. For the measurement, high voltages were applied to this spacer, and a voltage at which a dielectric breakdown occurs was plotted. The measurement was performed for five samples, and an average of the voltages at which dielectric breakdown occurs was plotted.

Each resistance of Rf and Rs was calculated as follows. First, Rs was measured without forming a thin film. Next, a thin film was formed on both ends of the substrate. Then, the volume resistivity Rt of the whole spacer was measured, and the resistance Rf of the thin film was calculated using an equivalent circuit as shown in FIG. 16. In FIG. 16, a relationship between Rt, Rf, and Rs is expressed by Equation 2.

$$\frac{1}{{R}_{t}} = \frac{1}{{R}_{f}} + \frac{1}{{R}_{f}} + \frac{1}{{R}_{s}} \qquad ( Equation 2 )$$

Accordingly, Equation 3 and Equation 4 are derived, and Rf can be calculated from Equation 5.

$$\begin{matrix}\frac{2}{{R}_{f}} = \frac{1}{{R}_{t}} - \frac{1}{{R}_{s}} & ( Equation 3 ) \\ \frac{2}{{R}_{f}} = \frac{{R}_{s} - {R}_{t}}{{R}_{t} \cdot {R}_{s}} & ( Equation 4 ) \\ {R}_{f} = \frac{2 {R}_{t} \cdot {R}_{s}}{{R}_{s} - {R}_{t}} & ( Equation 5 )\end{matrix}$$

Rf was determined by calculation using Equation 5. From, FIG. 15, it is understood that the smaller Rf, the lower the dielectric breakdown voltage becomes and that the dielectric breakdown will not occur if Rf is large. Now, assume that the voltage applied during normal image reproduction is 10V. Then, Rf/Rs at the time when dielectric breakdown occurs with this applied voltage equal to or higher than 10V is found to be equal to or greater than 0.01.

From this, it is preferable that a relationship between the electrical resistance Rf of the thin film and the electrical resistance Rs of a substrate satisfies 0.01 Rs≦Rf.

With the use of a spacer in which a thin film having the element and composition shown in Table 1 was formed on the surface of a glass substrate composed of a V—W—Mo—P—Ba—O base electronic conducting glass, an MIM type FED panel with the structure shown in FIG. 2 and FIG. 3 was prepared, and a voltage at which thermal runaway occurs and the amount of beam deflection were measured. Table 1 shows the film composition, corresponding schematic view, volume resistivity at room temperature, temperature coefficient of resistance evaluated from 25° C. to 40° C., withstand voltage, and amount of beam deflection. In addition, in Table 1, a thin film comprising 20 mol % of Au particles dispersed in 80 mol % of Fe₂O₃ matrix is expressed as 20Au-80Fe₂O₃. Moreover, an oxide matrix and oxide thin film containing a plurality of oxides are expressed as Fe₂O₃—Ga₂O₃, for example.

TABLE 1

| | | | | | Temperature | | |
|---|---|---|---|---|---|---|---|
| | | | Corresponding | Volume | coefficient of | Endurance | Deflection |
| | | | schematic | resistivity | resistance | Voltage | amount |
| | No. | Film composition | view | (GΩcm) | α (%/° C.) | (kV) | (μm) |
| Example | 101 | 50Au—35Fe2O3—15Ga2O3 | FIG. 4 | 0.92 | −1.65 | 12.0 | 20 |
| | | 50 nm | | | | | |
| | 102 | 50Pt—35Fe2O3—15Ga2O3 | FIG. 4 | 1.01 | −1.47 | 12.0 | 15 |
| | | 50 nm | | | | | |
| | 103 | 50Ag—35Fe2O3—15Ga2O3 | FIG. 4 | 0.85 | −1.65 | 12.0 | 20 |
| | | 50 nm | | | | | |
| | 104 | 50Cu—35Fe2O3—15Ga2O3 | FIG. 4 | 0.9 | −1.82 | 12.0 | 17 |
| | | 50 nm | | | | | |
| | 105 | 50Cr—35Fe2O3—15Ga2O3 | FIG. 4 | 0.92 | −1.45 | 12.0 | 17 |
| | | 50 nm | | | | | |
| | 106 | 50Au—35Fe2O3—15Ga2O3 | FIG. 4 | 2.71 | −2.14 | 12.0 | 20 |
| | | 20 nm | | | | | |
| | 107 | 50Au—35Fe2O3—15Ga2O3 | FIG. 4 | 0.61 | −1.57 | 11.5 | 20 |
| | | 100 nm | | | | | |
| | 108 | 50Au—35Fe2O3—15Ga2O3 | FIG. 4 | 0.35 | −1.29 | 10.5 | 16 |
| | | 200 nm | | | | | |
| | 109 | 20Au—80Fe2O3 | FIG. 4 | 0.72 | −1.25 | 12.0 | 15 |
| | | 20 nm | | | | | |
| | 110 | 60Au—40Ga2O3 | FIG. 4 | 0.44 | −1.86 | 12.0 | 17 |
| | | 50 nm | | | | | |
| | 111 | 20Au—80Cr2O3 | FIG. 4 | 0.52 | −1.22 | 12.0 | 20 |
| | | 20 nm | | | | | |

For the amount of beam deflection, an amount of beam deflection in an emitter disposed in a first line just proximal to a gate electrode where a spacer is formed was evaluated. The beam deflection is a phenomenon caused as follows. That is, if the electrical resistance of a spacer is high and the secondary electron emission coefficient is greater than 1 or smaller than 1, positive charges or negative charges are accumulated in the surface of a spacer, and an emission current is attracted by the charges accumulated in this surface if the charges accumulated in this surface are positive charges, and the emission current is repelled if the charges accumulated in this surface are negative charges. As a result, a position deviating from the center of a fluorescent substance on an anode substrate formed right above the emitter is irradiated with an electron beam to thereby cause the beam deflection. If beam deflection occurs, a region where a fluorescent substance does not emit light will occur and thereby a linear black belt will be observed along a spacer, which is therefore not preferable. The deviation amount of beam deflection was quantitatively evaluated using a magnifying glass, and the value of the deviation amount was entered on the table. If the beam deflection is equal to or less than 20 μm, human eyes can not observe a black belt caused by this deviation, which is therefore desirable.

Examples 101 to 111 have the configuration of FIG. 4, wherein a thin film comprising metal nano particles of Au, Pt, Ag, Cu, or Cr dispersed in a semiconductor metal oxide matrix of Fe₂O₃, Ga₂O₃, Cr₂O₃, or Ga₂O₃ was formed on the side surface of an electronic conducting glass substrate. The absolute value of the temperature coefficient of resistance for any one of these examples is smaller than 3.0, which is therefore preferable.

Examples 106 to 108 correspond to the case where the film thickness of an Au—Fe₂O₃—Ga₂O₃ based thin film was varied. This showed a tendency that the thinner the film thickness, the higher the resistance becomes and the larger the absolute value of the temperature coefficient of resistance becomes. This also showed a tendency that the thicker the film thickness, the lower the withstand voltage becomes.

On the other hand, as shown in Examples 101 to 111 of Table 1, when a semiconductor is used as a matrix element, a positive charge generated in the matrix portion is discharged due to conduction of the matrix portion. Accordingly, an emitted electron beam may not be attracted and therefore beam deflection may be suppressed.

### EXAMPLE 2

Next, a second spacer is described in detail.

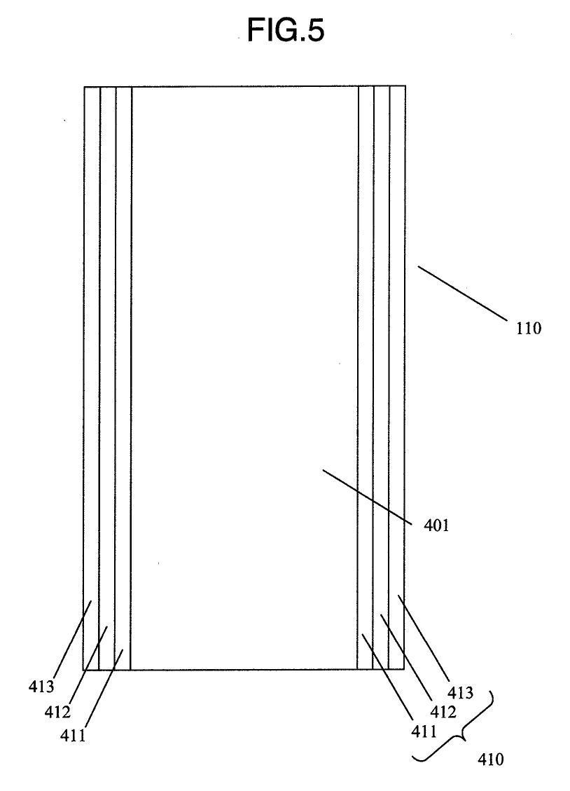

FIG. 5 shows a schematic view of the cross section of the spacer 110 prepared in this example. The spacer 110 includes, on the side surface of a glass substrate 401, a first metal oxide thin film 411 exhibiting semiconductor-like electrical conductivity, a second metal oxide thin film 412 exhibiting metal-like conductivity, and a third metal oxide thin film 413 exhibiting semiconductor-like electrical conductivity, in this order from the glass substrate side.

Here, as in Example 1, a V—W—Mo—P—Ba—O based electronic conducting glass was used in the glass substrate 401 of the spacer 110. The conductive glass was used because we though a current will flow through the glass substrate so that the withstand voltage may be increased and a bright image quality may be obtained. As the first metal oxide thin film 411, Ga₂O₃, Cr₂O₃, Fe₂O₃, and a complex oxide of Fe₂O₃ and Ga₂O₃ were used. As the second metal oxide thin film 412 exhibiting metallic conduction, a thin film that comprises metal particles composed of Au, Pt, Ag, Cr, or Cu dispersed in an oxide matrix of SiO₂, Ga₂O₃, Cr₂O₃, Fe₂O₃, a complex oxide of Fe₂O₃ and Ga₂O₃, Al₂O₃, Ta₂O₅, or the like was used. As the third metal oxide thin film 413, Ga₂O₃, Cr₂O₃, Fe₂O₃, or a complex oxide of Fe₂O₃ and Ga₂O₃ was used.

These thin films were deposited by sputtering. The deposition method is the same as that of Example 1. The deposition was carried out by sputtering in this example, however, as the deposition method, a coating and baking method via a solution, such as a spray method, a dip method, a sol-gel method, a dice method, and a spin coat method may be used.

The deposition method using sputtering carried out in this example is described. For the deposition of the first and third metal oxide thin films, a sintered body of a metal oxide having a desired composition was used as a target material, and the deposition was carried out using an rf sputtering method. As the forming gas, a mixed gas of Ar and 02 obtained by adding 5 vol. % of oxygen into a high purity Ar gas (99.9999%) was used. As the power supply, an rf magnetron power supply was used to apply a high voltage of approximately 700 W to the metal oxide sintered body target. The vacuum pressure inside the deposition chamber before deposition was set to 4.0×10⁻⁵ Pa.

For the deposition of the second metal oxide thin film, a 10 mm square metallic chip of Au, Pt, Ag, Cr, Cu, or the like was mounted on an erosion area of a sintered body target composed of a metal oxide, such as SiO₂, Ga₂O₃, Cr₂O₃, Fe₂O₃, a complex oxide of Fe₂O₃ and Ga₂O₃, Al₂O₃ or Ta₂O₅, so as to obtain a desired film composition, and the deposition was carried out. As the forming gas, a high purity Ar gas (99.9999%) was used. As the power supply, an rf magnetron power supply was used to apply a high voltage of approximately 700 W to the metal oxide sintered body target. The vacuum pressure inside the deposition chamber before deposition was set to 4.0×10⁻⁵ Pa. In addition, the size of the metal oxide sintered body target used for forming the first, second, and third thin films is 152.4 mm φ×5 mm t.

In order to analyze the composition after deposition, a film was formed in the thickness of approximately 200 nm on a polyimide film, and the composition analysis was conducted using ICP spectroscopy.

A film material was formed in the thickness from 20 nm to 50 nm on a V—W—Mo—P—Ba—O base electronic conducting glass substrate under the above-described sputtering condition. The size of the glass substrate was set to 110 mm×3 mm×0.15 mm, where deposition was carried out on a portion of 110 mm×3 mm. Since the sputtering rate of a film varies depending on the composition thereof, the deposition was carried out calculating the rate for each composition. After completion of the deposition on one side, the sample was taken out to the atmosphere once, and the deposition on the rear surface was carried out after the upper and lower sides are reversed. In this manner, the deposition under the same condition was carried out to the both sides of the spacer.

After completion of the deposition, Cr was formed in the thickness of approximately 100 nm as a metal film on the both end faces (110 mm×0.15 mm portion) of the spacer, the both end faces serving as a joint portion with the anode substrate and with the cathode substrate, respectively.

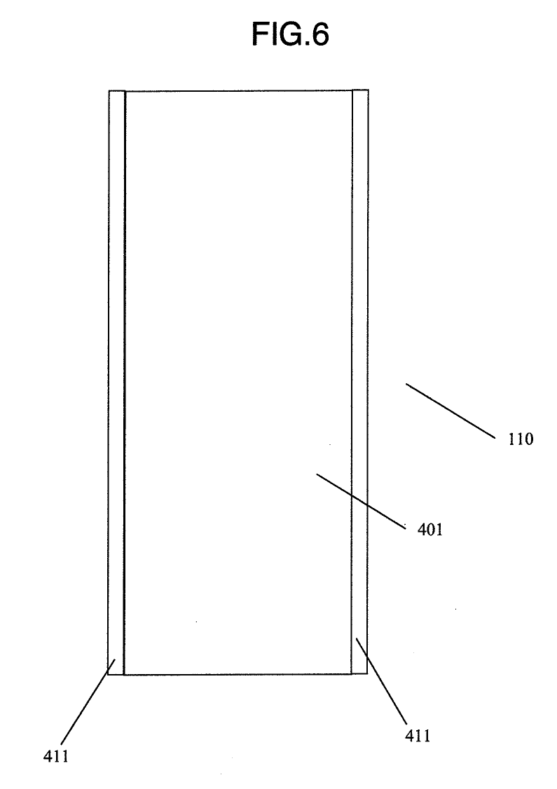

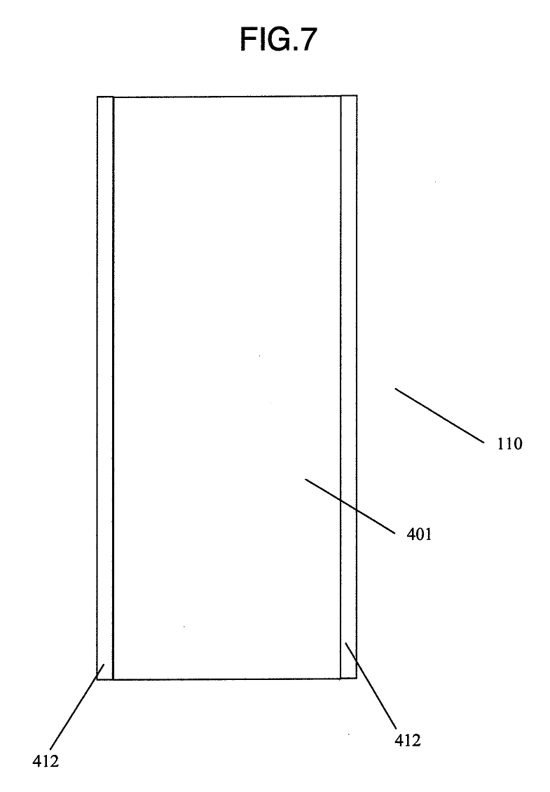

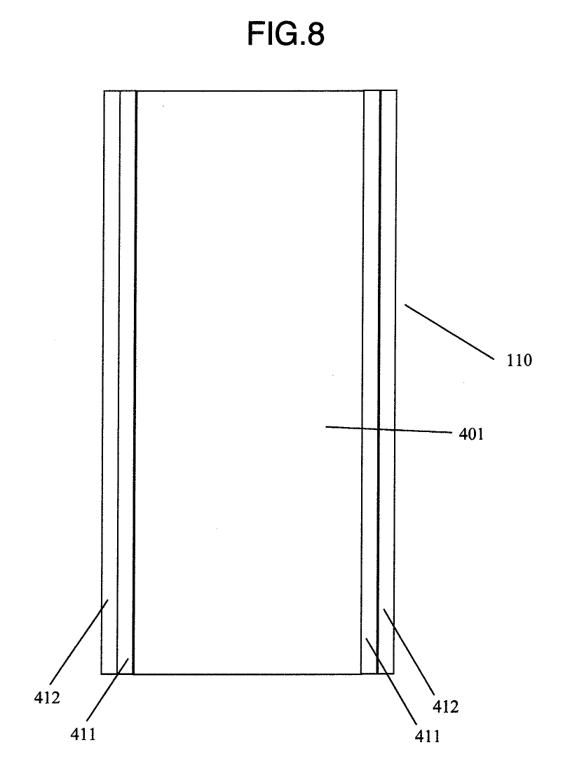

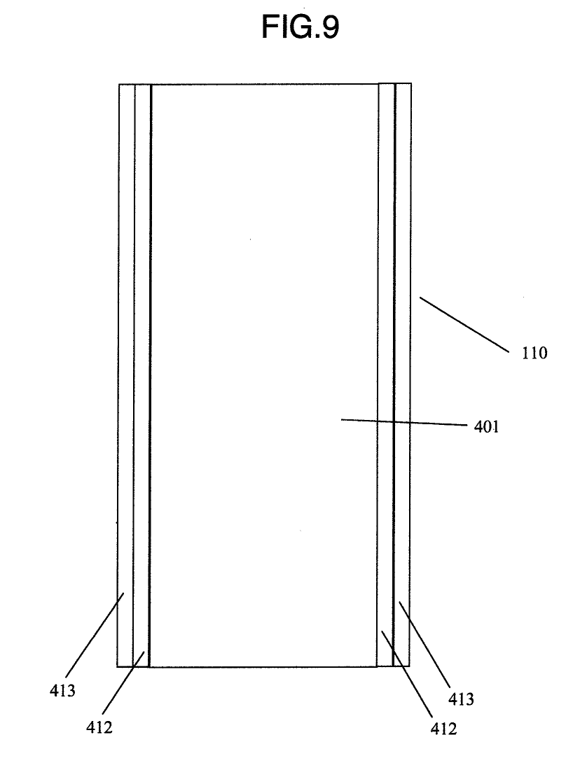

As comparative examples, spacer having thin film structures shown in FIG. 6 and FIG. 9 were prepared. FIG. 6 shows an example in which one layer of a first metal oxide thin film exhibiting semiconductor-like electrical conductivity 411 was formed on a spacer substrate. FIG. 7 shows an example in which one layer of a second metal oxide thin film exhibiting metal-like conductivity 412 was formed on a spacer substrate. FIG. 8 is an example in which firstly, the first metal oxide thin film exhibiting semiconductor-like electrical conductivity 411 was formed on a spacer substrate and thereafter the second metal oxide thin film exhibiting metal-like conductivity 412 was formed thereon to from a two-layer structure. Furthermore, FIG. 9 is an example in which firstly, the second metal oxide thin film exhibiting metal-like conductivity 412 was formed on a spacer substrate and thereafter a third metal oxide thin film 413 exhibiting semiconductor-like electrical conductivity was formed thereon to form a two-layer structure.

The FED panel shown in FIG. 2 was prepared using the spacer having the structures shown in FIG. 5 to FIG. 9, and the emission degradation, beam deflection, temperature dependence of beam deflection, withstand voltage, and time degradation of the panel were evaluated. Table 2 shows the evaluation results of the spacers. In Table 2, a complex oxide is expressed as Fe₂O₃—Ga₂O₃, for example.

TABLE 2

| | | Film Composition | | | Corresponding |
|---|---|---|---|---|---|
| No. | | First layer | Second layer | Third layer | schematic view |
| Example | 201 | Ga2O3 | 50Au—50SiO2 | Ga2O3 | FIG. 5 |
| | | 50 nm | 20 nm | 50 nm | |
| | 202 | 30Fe2O3—70Ga2O3 | 50Au—50SiO2 | 30Fe2O3—70Ga2O3 | FIG. 5 |
| | | 50 nm | 20 nm | 50 nm | |
| | 203 | 50Fe2O3—50Ga2O3 | 50Au—50SiO2 | 50Fe2O3—70Ga2O3 | FIG. 5 |
| | | 50 nm | 20 nm | 50 nm | |
| | 204 | 70Fe2O3—30Ga2O3 | 50Au—50SiO2 | 70Fe2O3—70Ga2O3 | FIG. 5 |
| | | 50 nm | 20 nm | 50 nm | |
| | 205 | Fe2O3 | 50Au—50SiO2 | Fe2O3 | FIG. 5 |
| | | 50 nm | 20 nm | 50 nm | |
| | 206 | Cr2O3 | 50Au—50SiO2 | Cr2O3 | FIG. 5 |
| | | 50 nm | 20 nm | 50 nm | |
| | 207 | 50Cr2O3—50Ga2O3 | 50Pt—50SiO2 | 50Cr2O3—50Ga2O3 | FIG. 5 |
| | | 50 nm | 20 nm | 50 nm | |
| | 208 | 50Fe2O3—50Ga2O3 | 50Ag—50SiO2 | 50Fe2O3—50Ga2O3 | FIG. 5 |
| | | 50 nm | 20 nm | 50 nm | |
| | 209 | 50Fe2O3—50Ga2O3 | 50Cr—50SiO2 | 50Fe2O3—50Ga2O3 | FIG. 5 |
| | | 50 nm | 20 nm | 50 nm | |
| | 210 | 50Fe2O3—50Ga2O3 | 50Cu—50SiO2 | 50Fe2O3—50Ga2O3 | FIG. 5 |
| | | 50 nm | 20 nm | 50 nm | |
| | 211 | 50Fe2O3—50Ga2O3 | 50Au—50Al2O3 | 50Fe2O3—50Ga2O3 | FIG. 5 |
| | | 50 nm | 20 nm | 50 nm | |
| | 212 | 50Fe2O3—50Ga2O3 | 50Au—50Ta2O5 | 50Fe2O3—50Ga2O3 | FIG. 5 |
| | | 50 nm | 20 nm | 50 nm | |
| | 213 | 50Fe2O3—50Ga2O3 | 50Au—50Ta2O5 | 50Fe2O3—50Ga2O3 | FIG. 5 |
| | | 50 nm | 20 nm | 50 nm | |
| | 214 | 50Fe2O3—50Ga2O3 | 50Au—50(FeGaO3) | 50Fe2O3—50Ga2O3 | FIG. 5 |
| | | 50 nm | 20 nm | 50 nm | |
| Comparative | 221 | 50Fe2O3—50Ga2O3 | — | — | FIG. 6 |
| Example | | 50 nm | | | |
| | 222 | 50Au—50SiO2 | — | — | FIG. 7 |
| | | 50 nm | | | |
| | 223 | 50Fe2O3—50Ga2O3 | 50Au—50SiO2 | — | FIG. 8 |
| | | 50 nm | 50 nm | | |
| | 224 | 50Au—50SiO2 | 50Fe2O3—50Ga2O3 | — | FIG. 9 |
| | | 50 nm | 50 nm | | |

| | | | | Temperature | | |
|---|---|---|---|---|---|---|
| | | Emission | Deflection | coefficient of | Endurance | |
| | | degradation | amount | deflection | voltage | Time |
| No. | | (ΔIe %) | (μm) | (μm/° C.) | (kV) | degradation |
| Example | 201 | 1.2 | 18 | 0.98 | 10.0 | ◯ |
| | 202 | 1.6 | 15 | 0.54 | 10.0 | ◯ |
| | 203 | 1.3 | 18 | 0.85 | 10.0 | ◯ |
| | 204 | 1.2 | 19 | 0.75 | 10.0 | ◯ |
| | 205 | 1.1 | 21 | 0.87 | 10.0 | ◯ |
| | 206 | 0.8 | 20 | 0.91 | 10.0 | ◯ |
| | 207 | 0.1 | 12 | 0.52 | 10.0 | ◯ |
| | 208 | 0.2 | 19 | 0.88 | 10.0 | ◯ |
| | 209 | 0.8 | 16 | 0.79 | 10.0 | ◯ |
| | 210 | 1.0 | 18 | 0.66 | 10.0 | ◯ |
| | 211 | 1.2 | 16 | 0.75 | 10.0 | ◯ |
| | 212 | 1.1 | 14 | 0.89 | 10.0 | ◯ |
| | 213 | 0.9 | 12 | 0.97 | 10.0 | ◯ |
| | 214 | 1.5 | 17 | 0.85 | 10.0 | ◯ |
| Comparative | 221 | 1.3 | 18 | 5.82 | 10.0 | ◯ |
| Example | 222 | 1.4 | 132 | 0.98 | 7.5 | X |
| | 223 | 0.8 | 140 | 0.85 | 8.5 | X |
| | 224 | 1.7 | 17 | 0.80 | 7.0 | ◯ |

In Table 2, for the emission degradation, a value δIe was evaluated, the value δIe being obtained by normalizing a difference between an emission current value in an emitter disposed in the first line just proximal to a gate electrode where a spacer is formed and an emission current value from an emitter at 20 lines away from the spacer by the emission current value from an emitter at 20 lines away from the spacer. Equation 6 is the calculation formula for δIe.

$$Δ {I}_{e} = \frac{( {I}_{e ( 20 )} - {I}_{e ( 1 )} )}{{I}_{e ( 20 )}} \times 100 \qquad ( Equation 6 )$$

In Equation 6, Ie₍₂₀₎ is an emission current value from an emitter at 20 lines away from a spacer, and Ie₍₁₎ is an emission current value in an emitter disposed in the first line just proximal to a gate electrode where the spacer is formed. Moreover, the deviation amount of beam deflection was quantitatively evaluated using a magnifying glass, and the value of the deviation amount was entered on the table. The amount of beam deflection equal to or less than 20 μm is preferable because human eyes can not observe a black belt caused by this deviation.

The beam deflection is a phenomenon caused as follows. That is, if the electrical resistance of a spacer is high and the secondary electron emission coefficient is greater than 1 or smaller than 1, positive charges or negative charges are accumulated in the surface of the spacer, and an emission current is attracted by the charges accumulated in this surface if the charges accumulated in this surface are positive charges, and the emission current is repelled if the charges accumulated in this surface are negative charges. As a result, a position deviating from the center of a fluorescent substance on an anode substrate formed right above the emitter is irradiated with an electron beam to thereby cause the beam deflection. If beam deflection occurs, a region where a fluorescent substance does not emit light will occur and thereby a linear black belt will be observed along a spacer, which is therefore not preferable.

Moreover, the temperature dependence of beam deflection is caused by the temperature dependence of resistance of a spacer and occurs depending on the temperature difference between an anode substrate and a cathode substrate. If the amount of beam deflection per 1° C. of the temperature difference between an anode substrate and a cathode substrate is equal to or less than 1 μm, the amount of beam deflection is equal to or less than 20 μm even when the temperature difference between the anode and the cathode is 20° C., which is therefore preferable. Table 2 shows the amount of beam deflection per 1° C. of the temperature difference between an anode and a cathode. In addition, the temperatures of an anode and a cathode were measured using an infrared radiation thermometer. Moreover, the temperature difference was generated by increasing the temperature of an anode with an air heater while the temperature of a cathode was fixed to 25° C., and then measurement was carried out.

For the withstand voltage, voltages from 4 kV to 10 kV were applied to between an anode and cathode of a prepared panel, and a voltage at which a failure, such as a spark or thermal runaway of a spacer, starts to occur in the spacer portion was entered on the table. Practically, the withstand voltage is preferably equal to or higher than 10 kV.

For the time degradation, a continuous lighting experiment for 20, 000 hours was conducted, and a “circle” mark was put on the table when the above-described emission degradation, beam deflection, spark, thermal runaway, etc., did not occur, while a “×” mark was put on the table when these failures occurred with time and the result was worse that the above-described indexes.

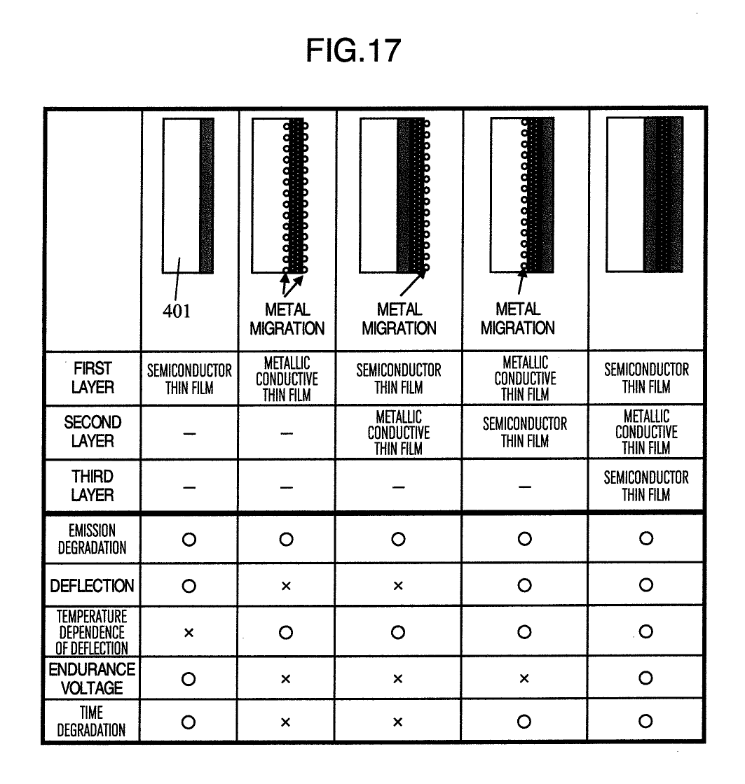

The above results are put together and shown in FIG. 17.

As shown in Table 2 and FIG. 17, it was found out that spacers, on which the first, second, and third thin films are successively formed, have characteristics excellent in all the items of emission degradation, beam deflection, temperature dependence of beam deflection, withstand voltage, and time degradation. In comparative examples shown in FIG. 6, the temperature dependence of beam deflection was not preferable because the second metal oxide thin film exhibiting metallic conductivity is not formed. In comparative examples of FIG. 7 and FIG. 8, the beam deflection and withstand voltage were not preferable probably because SiO₂, which is an insulator, is used in a matrix of the second thin film exhibiting metal-like electrical conductivity. In addition, when this matrix was changed from an insulator to a semiconductor oxide, time degradation occurred and thermal runaway was likely to occur due to a decrease in the resistance.

In the spacer shown in FIG. 9 in which the second metal oxide thin film and third metal oxide thin film are successively formed on a glass substrate, the withstand voltage was poor. When the spacers shown in FIG. 7 to FIG. 9 having a poor withstand voltage were taken out and observed with a transmission electron microscope after the test, a phenomenon that metal particles dispersed in the second metal oxide thin film exhibiting metallic conductivity diffuse in the surface of the glass substrate was observed, or segregation on the surface of the glass substrate due to migration of the metal particles was observed. This may have occurred due to a heating process during panel manufacture. Due to this segregation, the resistance may decrease and thus too much current may flow by application of a high voltage, thereby causing a thermal runaway.

In the spacer of the present invention shown in FIG. 5, a semiconductor thin film exists on both the front and back sides of the second layer composed of an oxide thin film containing metal nano particles. For this reason, even if migration of a metal particle occurs due to heating during panel manufacture and a metal nano particle diffuses into the semiconductor thin film, the metal nano particle will not precipitate on the surface or on the glass substrate interface because of the presence of the first and third layers. Accordingly, thermal runaway or the like due to segregation will not occur. Furthermore, since a thin film exhibiting metallic conduction is not exposed on the uppermost surface, the spacer will not be charged by an electron beam directly hitting against the uppermost surface even when an insulator such as SiO₂ is used, which is therefore preferable.

### EXAMPLE 3

Next, a third spacer is described in detail.

Spacers with configurations shown in Examples 301 to 310 and Comparative Examples 311 to 314 of Table 3 were prepared, and various characteristics were studied.

TABLE 3

| | | | | | | Layer thickness | |
|---|---|---|---|---|---|---|---|
| | | | | | | of metal oxide | |
| | | | Film | Metallic | Particle | in the surface | |
| | | Metal | thickness | conductive | diameter | of particle | Content |
| | No. | oxide film | (nm) | particle | (nm) | (nm) | (mol %) |
| Example | 301 | Fe₂O₃:Ga₂O₃(1:1) | 50 | Silica-coated Au | 3 | 1 | 40 |
| | | | | particle | | | |
| | 302 | Fe₂O₃:Ga₂O₃(1:1) | 50 | Silica-coated Au | 3 | 1 | 60 |
| | | | | particle | | | |
| | 303 | Fe₂O₃:Ga₂O₃(1:1) | 50 | Silica-coated Pt | 3 | 1 | 40 |
| | | | | particle | | | |
| | 304 | Fe₂O₃:Ga₂O₃(1:1) | 50 | Silica-coated Ag | 3 | 1 | 40 |
| | | | | particle | | | |
| | 305 | Fe₂O₃:Ga₂O₃(3:7) | 50 | Silica-coated Au | 3 | 1 | 40 |
| | | | | particle | | | |
| | 306 | Mn₂O₃:Ga₂O₃(1:1) | 50 | Silica-coated Au | 3 | 1 | 40 |
| | | | | particle | | | |
| | 307 | Cr₂O₃:Ga₂O₃(1:1) | 50 | Silica-coated Au | 3 | 1 | 40 |
| | | | | particle | | | |
| | 308 | Fe₂O₃:Al₂O₃(1:1) | 50 | Silica-coated Au | 3 | 1 | 40 |
| | | | | particle | | | |
| | 309 | Fe₂O₃:Ga₂O₃(1:1) | 5 | Silica-coated Au | 3 | 1 | 40 |
| | | | | particle | | | |
| | 310 | Fe₂O₃:Ga₂O₃(1:1) | 300 | Silica-coated Au | 3 | 1 | 40 |
| | | | | particle | | | |
| Comparative | 311 | Fe₂O₃:Ga₂O₃(1:1) | 50 | — | — | — | 0 |
| Example | 312 | SiO₂ | 50 | Au particle | 3 | 1 | 40 |
| | 313 | Fe₂O₃ | 50 | Silica-coated Au | 3 | 1 | 40 |
| | | | | particle | | | |
| | 314 | Ga₂O₃ | 50 | Silica-coated Au | 3 | 1 | 40 |
| | | | | particle | | | |

| | | | Temperature | | |
|---|---|---|---|---|---|
| | | Volume | coefficient of | Endurance | Deflection |
| | | resistivity | resistance | Voltage | amount |
| | No. | (GΩcm) | α (%/° C.) | (kV) | (μm) |
| Example | 301 | 0.95 | −1.70 | 12.0 | 20 |
| | 302 | 0.72 | −1.22 | 12.0 | 18 |
| | 303 | 1.05 | −1.47 | 12.0 | 15 |
| | 304 | 0.89 | −1.65 | 12.0 | 20 |
| | 305 | 1.19 | −1.63 | 12.0 | 17 |
| | 306 | 1.05 | −1.83 | 12.0 | 19 |
| | 307 | 0.15 | −1.76 | 12.0 | 18 |
| | 308 | 1.12 | −1.71 | 12.0 | 20 |
| | 309 | 10.1 | −3.18 | 12.0 | 20 |
| | 310 | 0.09 | −1.54 | 9.0 | 18 |
| Comparative | 311 | 1.26 | −3.21 | 12.0 | 20 |
| Example | 312 | 0.62 | −1.52 | 10.5 | 150 |
| | 313 | 0.08 | −1.71 | 12.0 | 18 |
| | 314 | 1.52 | −1.68 | 12.0 | 110 |

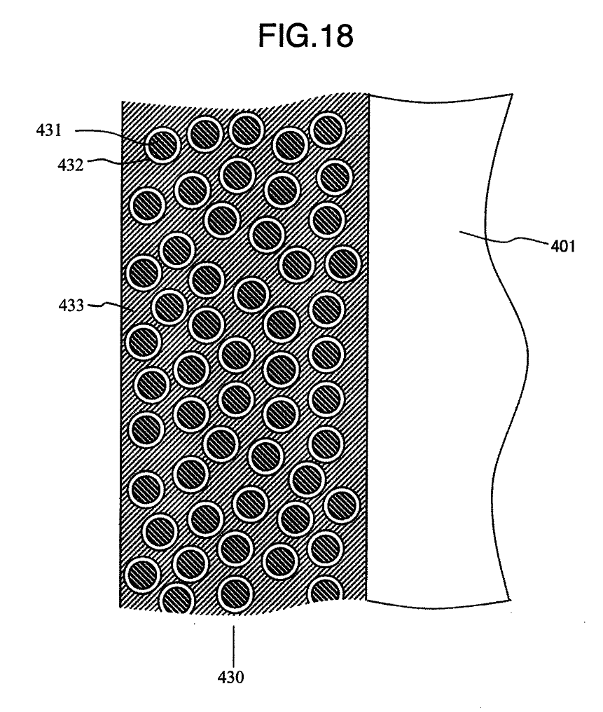

FIG. 4 is a schematic view of the cross section of a spacer concerning the present invention, and FIG. 18 is a schematic view showing the composition of a thin film formed on the side surface of a glass substrate. The spacer 110 of the present invention comprises the glass substrate 401 and a thin film 430 covering the side surface thereof, wherein the thin film 430 comprises, as shown in FIG. 18, a particle exhibiting metallic conductivity 431, a metal oxides 432 having an insulator-like electrical characteristic and covering the surface the particle, and a composite metal oxides 433.

All the examples of the present invention and the comparative examples used a V—W—Mo—P—Ba—O based electronic conducting glass in the glass substrate of a spacer. The conductive glass was used because we though a current may flow through the substrate to increase the withstand voltage and thereby a bright image quality may be obtained.

A thin film of Comparative Example 311 comprises only a composite metal oxide of Fe₂O₃ and Ga₂O₃ and does not include a metal particle and a film covering the same. A thin film of Comparative Example 312 comprises a silica into which an Au particle is dispersed, and does not contain a composite metal oxide. In Comparative Example 313 and Comparative Example 314, a silica-coated Au particle is dispersed into a single metal oxide, not into a composite metal oxide. For all the spacers of the examples of the present invention and the comparative examples, a thin film was deposited on the side surface of a glass substrate using a spray coat method, however, a coating and baking method via a solution, such as a dip method, a sol-gel method, a dice method, or a spin coat method, may be used.

The deposition method by spray coating is described taking a thin film having the composition of Example 301 as an example. An Au particle having a metal oxide layer composed of SiO₂ was prepared with a liquid phase method. After adding 5×10⁻⁴ mol of citric acid into 100 mL of citric acid (5 mM), 100 μL of NaBH₄ was added to form a gold nano particle stabilized with the citric acid. The average crystal diameter of the gold nano particle observed with TEM was 4 nm. After adding 0.5 mL of (3-aminopropyl) trimethoxysilane (1 mM), 4 mL of 0.45 wt % sodium silicate aqueous solution was added (by means of ion-exchange resin) to adjust pH to 9, followed by stirring for 24 hours. Furthermore, 20 mL of toluene and 0.5 mL of hexyltrimethoxysilane (1 mM) were added, and then after stirring for 5 hours, the toluene phase was extracted. The silica coating thickness of the formed silica-coated gold nano particle was 2 nm.

Fe₂O₃ coating liquid (oxide concentration of 3%) (Fe—O₃) and Ga₂O₃ coating liquid (oxide concentration of 3%) (Ga—O₃) manufactured by Kojundo Chemical Laboratory were mixed to obtain a solution with the mole ratio of 1:1. Into this solution, a toluene solution of silica-coated gold nano particles was added as to be 40 mol % or 60 mol % with respect to a composite metal oxide thin film of Fe₂O₃ and Ga₂O₃. The resultant solution was used as a spray coating liquid. Spray coating was performed with the nozzle diameter of 0.2 mm, at the atomizing pressure of 2 atm., and at the atomizing distance of 20 cm.

A film material was formed on both sides of a V—W—Mo—P—Ba—O based electronic conducting glass substrate under the above-described spray coating conditions. The size of the substrate was set to 110 mm×3 mm×0.15 mm, where deposition was carried out on a portion of 110 mm×3 mm. After spray coating, a spacer was calcined at 460° C. for 1 hour to form a 50 nm thick thin film.

After completion of deposition, Cr was formed by sputtering in the thickness of approximately 100 nm as the metal film on the both end faces (110 mm×0.15 mm portion) of the spacer, the both end faces serving as a joint portion with the anode substrate and with the cathode substrate, respectively.

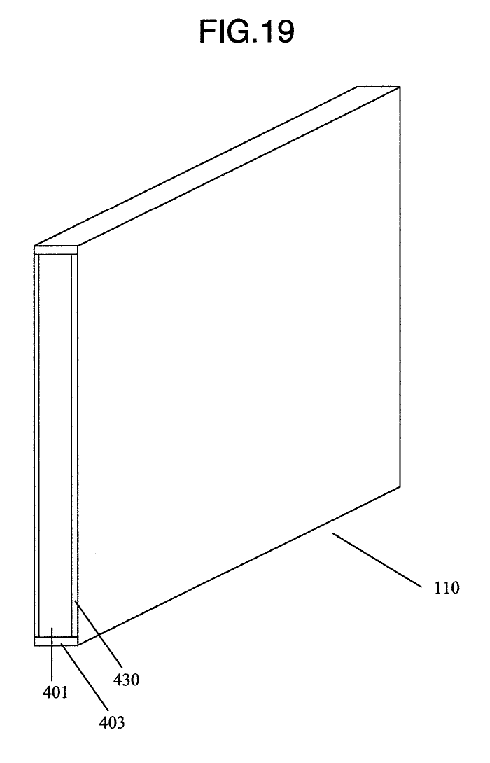

The temperature dependence of electrical resistance was evaluated for the prepared thin film. FIG. 19 shows a schematic view of the shape of a spacer sample used for this measurement. The thin film 430 was formed on the side surface of the glass substrate 401, and a chromium metal 403 was formed as an electrode in 100 nm thickness on both ends. A high voltage of approximately 500 V was applied to between these electrodes to measure the volume resistivity. The size of the sample was 3 mm in height, 0.110 mm in width, and 10 mm in length. This sample was pinched between high voltage electrodes, and the whole of these was held in a temperature controlled bath capable of being heated to 125° C., and while varying the temperature, the volume resistance at each temperature was measured. For the measurement, the sample was heated to 125° C. first and thereafter the resistance was measured during temperature fall.

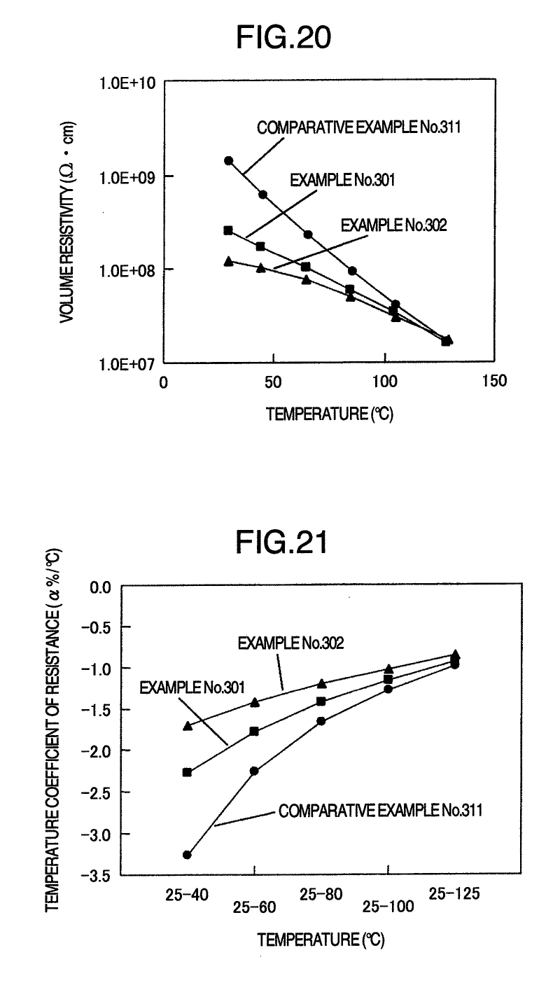

FIG. 20 shows the temperature changes in volume resistivity for Example 301, Example 302, and Comparative Example 311. In Example 301 and Example 302 in which silica-coated gold nano particles are dispersed in a composite metal oxide, the temperature change in volume resistance is small. On the other hand, in Comparative Example 311 which does not contain a silica-coated metal particle, the temperature change in resistance was extremely large to around room temperature.

FIG. 21 shows the temperature change of the temperature coefficient of resistance (α (%/° C.)) of a thin film for Example 301, Example 302, and Comparative Example 311. In FIG. 21, the temperature coefficient of resistance was calculated using Equation 1. While the temperature coefficient of resistance of Comparative Example 311 from 25° C. to 40° C. was approximately −3.21%/° C., in Example 302 it was approximately −1.70%/° C. and thus a significant improvement could be achieved.

However, the temperature coefficient of resistance around 125° C. for the both samples was approximately −1.1%/° C. It was found that if the absolute value of the temperature coefficient of resistance is within 3.0%/° C., the variation of deflection amount when temperature changed by 1° C. is equal to or less than 1 μm. In this case, when the temperature difference between an anode and a cathode is equal to or higher than 20° C., the deflection amount exceeds 20 μm, so that a shadow of a spacer can be seen on a screen. However, if the absolute value of the temperature coefficient of resistance is equal to or less than 3.0%/° C., the deflection amount is equal to or less than 20 μm even when the temperature difference between an anode and a cathode is 20° C., which is therefore preferable.

Next, the prepared spacer was mounted on an MIM type FED structure to prepare the FED panel shown in FIG. 2 and FIG. 3, and a voltage at which thermal runaway occurs and the amount of beam deflection were measured. Table 3 shows the film composition, volume resistivity at room temperature, temperature coefficient of resistance evaluated from 25° C. to 40° C., withstand voltage, and amount of beam deflection for various types of studied thin film materials.

The amount of beam deflection in an emitter disposed in the first line just proximal to a gate electrode where a spacer is formed was evaluated. The beam deflection is a phenomenon caused as follows. That is, if the electrical resistance of a spacer is high and the secondary electron emission coefficient is greater than 1 or smaller than 1, positive charges or negative charges are accumulated in the surface of the spacer, and an emission current is attracted by the charges accumulated in this surface if the charges accumulated in this surface are positive charges, and the emission current is repelled if the charges accumulated in this surface are negative charges. As a result, a position deviating from the center of a fluorescent substance on an anode substrate formed right above the emitter is irradiated with an electron beam to thereby cause the beam deflection.

If beam deflection occurs, a region where a fluorescent substance does not emit light will occur and thereby a linear black belt will be observed along a spacer, which is therefore not preferable. In Table 3, the deviation amount of beam deflection was quantitatively evaluated using a magnifying glass, and the value of the deviation amount was entered on the table. If beam deflection is equal to or less than 20 μm, human eyes can not observe a black belt caused by this deviation, which is therefore desirable.

The absolute value of the temperature coefficient of resistance for any one of the examples according to the present invention is smaller than 3.0, which is therefore preferable. When the amount of dispersion of Au particles contained in a composite metal oxide thin film is varied, as apparent from comparison between Example 301 and Example 302, as the amount of dispersion increases, the resistance tends to decrease and the absolute value of the temperature coefficient of resistance tends to decrease. Example 305 is an example in which the composition ratio of a composite metal oxide was set to Fe₂O₃:Ga₂O₃=3:7. Here, as the ratio of Fe₂O₃ decreases, the volume resistivity tends to decrease.

On the other hand, when an Fe₂O₃—Ga₂O₃ semiconductive thin film, into which a metal nano particle was not dispersed, is formed (Comparative Example 311), the deflection at room temperature was as good as 20 μm since the absolute value of the temperature coefficient of resistance exceeds 3.0, but the variation of deflection with temperature change was significant, which was not good.

In Comparative Example 312 using SiO₂ as the oxide thin film, the temperature coefficient of resistance was good, but the deflection amount is 150 μm (attraction), which is not preferable. This may be because charges were accumulated in the matrix portion. When an Fe₂O₃ thin film was used in place of a complex oxide thin film (Comparative Example 313), the volume resistivity was as small as 0.08 GΩ, which was not preferable. Moreover, when a Ga₂O₃ thin film was used in place of a complex oxide thin film (Comparative Example 314), the deflection amount was as large as 110, which was not preferable.

In Example 309 in which the film thickness of a composite metal oxide thin film was set to 5 nm, the deflection at room temperature was as good as 20 μm, but the absolute value of the temperature coefficient of resistance exceeded 3.0. Moreover, in Example 310 in which the film thickness of a composite metal oxide thin film was set to 300 nm, the volume resistivity was as small as 0.09 GΩ and an unevenness in film was likely to occur. This confirmed that the thickness of the thin film should be thicker than 5 nm and thinner than 300 nm.

### EXAMPLE 4

Next, a fourth spacer is described in detail.

In this example, a study was conducted paying attention to an RuₓM₍₁₋ₓ₎O₂ based thin film having an AₓB₍₁₋ₓ₎O_{y} structure as the oxide exhibiting metal-like electrical conductivity. Here, M denotes a tetravalent positive ion. Hereinafter, the reason for paying attention to this material system is described. In order to reduce the beam deflection of an electron beam and further eliminate the temperature dependence thereof, it is effective to form on the spacer surface a substance exhibiting metallic electronic conductivity. However, the resistance of the thin film exhibiting metallic electronic conductivity is typically too low, so that an excess current will flow and because of heat generation due to this current, there is apprehension that a spacer may blow out. Accordingly, it is necessary to increase the resistance while maintaining the metal-like electrical conductivity.

Thus, as one of the materials exhibiting high resistance and metallic electronic conductivity, the so-called cermet film, in which oxidation-resistant noble metal micro particles of Au, Pt, Ag, or the like are dispersed in an insulator matrix of SiO₂ or Al₂O₃, is listed. However, in this film, when an electron beam and/or reflection electrons are emitted onto the insulator matrix, secondary electrons are emitted accordingly and thereby holes are formed in this insulator portion. Since these are not grounded in the insulator matrix, the surface is charged to positive and as a result the electron beam is attracted, which is not preferable.

On the other hand, as a thin film exhibiting metal-like electrical conductivity, a thin film such as a ruthenium oxide is also proposed, however, this film is hardly appropriate as the material for the spacer because the resistance thereof is also low.

Then, the present inventors found out that the resistance can be increased on the order of a single molecule by dissolving an insulating ion into a ruthenium oxide. That is, higher resistance is achieved by replacing an Ru ion exhibiting electronic conductivity in a ruthenium oxide with another ion not exhibiting electronic conductivity. When forming a mixture without forming a solid solution, the surface is charged to positive as in the case of a cermet film because the mixed material is a high resistance material, which is not preferable.

In order to achieve such a system, if a material has the same valence (quadrivalent) as that of Ru and has the ionic radius similar to that of Ru and also has a high electrical resistance, this material can replace the Ru ion, thus allowing the electrical resistance to be increased further.

Then, first, in order to study an ion having such characteristic, a thin film of a mixture of an oxide (MO₂) containing a tetravalent positive ion and a ruthenium oxide was formed to study a material satisfying such conditions. In Table 4, the studied positive ions of tetravalent oxide, and thin film composition, ionic radius excerpted from Shannon's ionic radius table, ionic-radius ratio (rRu/rM) with respect to the Ru ion, precipitated phase, presence or absence of solid solution formation, and volume resistivity (Ωcm) are shown.

TABLE 4

| | | Thin film | Radius of | Ionic radius | | Formation | Volume |
|---|---|---|---|---|---|---|---|
| | Additive | composition | tetravalention | ratio | Precipitated | of solid | resistivity |
| | element | (mol %) | (A) | (rRu/rM) | phase | solution | (Ωcm) |
| Example 401 | Ti | 40RuO₂—60TiO₂ | 0.745 | 0.98 | RuO₂ | ◯ | 1.6 × 10⁶ |
| Example 402 | Ir | 40RuO₂—60IrO₂ | 0.765 | 1.01 | RuO₂ | ◯ | 2.1 × 10⁶ |
| Example 403 | Mo | 40RuO₂—60MoO₂ | 0.790 | 1.04 | RuO₂ | ◯ | 7.0 × 10⁻⁵ |
| Example 404 | Sn | 40RuO₂—60SnO₂ | 0.830 | 1.09 | RuO₂ | ◯ | 1.3 × 10⁻⁴ |
| Example 405 | Hf | 40RuO₂—60HfO₂ | 0.850 | 1.12 | RuO₂ | ◯ | 4.9 × 10⁶ |
| Example 406 | Zr | 40RuO₂—60ZrO₂ | 0.860 | 1.13 | RuO₂ | ◯ | 4.2 × 10⁶ |
| Comparative | Si | 40RuO₂—60SiO₂ | 0.540 | 0.71 | RuO₂, SiO₂ | X | 2.2 × 10¹ |
| Example 411 | | | | | | | |
| Comparative | Mn | 40RuO₂—60MnO₂ | 0.670 | 0.88 | RuO₂, MnO₂ | X | 3.4 × 10⁻⁴ |
| Example 412 | | | | | | | |
| Comparative | Ge | 40RuO₂—60GeO₂ | 0.670 | 0.88 | RuO₂, GeO₂ | X | 4.8 × 10¹ |
| Example 413 | | | | | | | |
| Comparative | Te | 40RuO₂—60TeO₂ | 1.110 | 1.46 | RuO₂, TeO₂ | X | 4.0 × 10⁰ |
| Example 414 | | | | | | | |
| Comparative | W | 40RuO₂—60WO₂ | 0.800 | 1.05 | RuO₂, WO₃ | X | 2.8 × 10⁻⁵ |
| Example 415 | | | | | | | |
| Comparative | Fe | 40RuO₂—60FeO₂ | 0.725 | 0.73 | RuO₂, Fe₂O₃ | X | 1.5 × 10⁻⁴ |
| Example 416 | | | | | | | |
| Comparative | Ru | 100RuO₂ | 0.760 | 1.00 | RuO₂ | — | 3.0 × 10⁻⁶ |
| Example 417 | | | | | | | |

In this study, for the presence or absence of formation of a solid solution in a thin film of 40RuO₂-60MO₂ in mol ratio (M: additive element), precipitated phase is first identified by thin film X ray diffraction, and when only a peak of RuO₂ was observed, this was further confirmed by evaluating a plane nano structure by means of a transmission electron microscope. If an additive phase was not observed, a “circle” mark was entered on the table, and when segregation of an additive element was observed by either of the analytical methods of thin film X ray diffraction and transmission electron microscope, then a “×” mark was entered on the table.

From Table 4, it was found that when an oxide of Ti, Ir, Mo, Sn, Hf, or Zr was added as the tetravalent positive ion M, segregation of these components was not seen, and that RuO₂ and these oxides formed a solid solution. Moreover, it was found that when an oxide of Si, Mn, Ge, Te, W, or Fe was added, segregation of these additive elements was confirmed and a solid solution was not formed. Paying attention to the ionic radius ratio (rRu/rM) of Ru and the additive element M, it was found that a solid solution could be formed when this ratio is over 0.88 and equal to or less than 1.13.

However, as shown in Comparative Examples 415 and 416, when an oxide of W or Fe was selected as an additive element, an oxide of these did not dissolve into RuO₂ but segregation of these was observed because for the oxide of these elements a hexad WO₃ was stable in the case of W and a trivalent Fe₂O₃ was stable in the case of Fe.

From above, when an oxide exhibiting metal-like electrical conductivity such as RuO₂ is denoted by AO_{y}, and an oxide that is added therein to form a solid solution and has a higher resistance than the former oxide is denoted by BO_{y}, if a ratio R_{A}/R_{B} of an ion radius R_{A} of AO_{y} and an ionic radius R_{B} of BOₓ is over 0.88 and equal to or less than 1.13, excellent characteristics in forming a solid solution could be obtained. Moreover, the valences of both metallic element A and metallic element B constituting the oxides AO_{y} and BOₓ were preferably equal.

Next, paying attention to the volume resistivity, it was found that among the oxides of Ti, Ir, Mo, Sn, Hf, and Zr that allow for formation of a solid solution, in the case of addition of Mo or Sn, such a high resistance could not be achieved as compared with that of the volume resistivity of RuO₂ shown in Comparative Example 417. This may be due to the fact that it is difficult to achieve a high resistance because the semiconductor-like property of these oxides themselves is strong. From above, it was found that as the additive elements that can form a solid solution by being added into RuO₂ and can achieve high resistance, oxides of Ti, Ir, Hf, and Zr are effective.

Next, the composition dependency of volume resistivity was studied using oxides of Ti, Ir, Hf, and Zr among the oxides that achieved excellent results in Table 4. Moreover, the MIM type FED panel shown in FIG. 2 and FIG. 3 was prepared, and the amount of beam deflection of an electron beam emitted from an emitter around a spacer and the power consumption were evaluated. Table 5 shows the composition, film thickness, electrical resistance, and temperature coefficient of resistance from room temperature to 40° C. of prepared thin films. The temperature coefficient of resistance (α (%/° C.)) was calculated using Equation 1. The temperature coefficient of resistance of a V—W—Ba—P based electronic conducting glass substrate used in this study was −3.3%/° C.

TABLE 5

| | | | | | Temperature | | |
|---|---|---|---|---|---|---|---|
| | | | Film | Volume | coefficient of | Power | Deflection |
| | | Film Composition | thickness | resistivity | resistance | consumption | amount |
| No. | | (mol %) | (nm) | (Ωcm) | α (%/° C.) | (W) | (μm) |
| Example | 501 | 40RuO₂—60TiO₂ | 40 | 1.6 × 10⁶ | −1.45 | 20.0 | −17 |
| | 502 | 30RuO₂—70TiO₂ | 50 | 3.3 × 10⁷ | −1.82 | 12.0 | −19 |
| | 503 | 20RuO₂—80TiO₂ | 65 | 8.5 × 10⁸ | −2.15 | 3.2 | −20 |
| | 504 | 40RuO₂—60IrO₂ | 40 | 2.1 × 10⁶ | −1.33 | 19.0 | −15 |
| | 505 | 30RuO₂—70IrO₂ | 50 | 5.2 × 10⁷ | −1.96 | 10.0 | −17 |
| | 506 | 20RuO₂—80IrO₂ | 65 | 3.2 × 10⁸ | −2.42 | 5.0 | −20 |
| | 507 | 40RuO₂—60HfO₂ | 40 | 4.9 × 10⁶ | −1.63 | 19.0 | −18 |
| | 508 | 30RuO₂—70HfO₂ | 50 | 6.3 × 10⁷ | −1.91 | 9.0 | −18 |
| | 509 | 20RuO₂—80HfO₂ | 65 | 2.1 × 10⁸ | −2.22 | 7.2 | −20 |
| | 510 | 40RuO₂—60ZrO₂ | 40 | 4.2 × 10⁶ | −1.62 | 20.0 | −17 |
| | 511 | 30RuO₂—70ZrO₂ | 50 | 7.1 × 10⁷ | −1.90 | 10.5 | −19 |
| | 512 | 20RuO₂—80ZrO₂ | 65 | 2.1 × 10⁸ | −2.21 | 7.0 | −19 |
| Comparative Example | 521 | 100RuO₂ | 5 | 3.2 × 10⁻⁶ | −1.02 | 2120.0 | −150 |
| | 522 | 50RuO₂—50TiO₂ | 10 | 2.1 × 10⁻¹ | −1.18 | 612.0 | −100 |
| | 523 | 10RuO₂—90TiO₂ | 75 | 1.7 × 10⁹ | −3.27 | 1.8 | 170 |
| | 524 | 100TiO₂ | 100 | 6.5 × 10⁹ | −3.30 | 0.9 | 200 |
| | 525 | 50RuO₂—50IrO₂ | 10 | 1.8 × 10⁻¹ | −1.19 | 590.0 | −120 |
| | 526 | 10RuO₂—90IrO₂ | 75 | 2.2 × 10⁹ | −3.25 | 1.5 | 16 |
| | 527 | 100IrO₂ | 100 | 7.2 × 10⁹ | −3.30 | 0.8 | 180 |
| | 528 | 50RuO₂—50HfO₂ | 10 | 2.8 × 10⁻¹ | −1.21 | 512.0 | −110 |
| | 529 | 10RuO₂—90HfO₂ | 75 | 2.0 × 10⁹ | −3.21 | 1.5 | 160 |
| | 530 | 100HfO₂ | 100 | 7.7 × 10⁹ | −3.32 | 0.9 | 210 |
| | 531 | 50RuO₂—50ZrO₂ | 10 | 1.5 × 10⁻¹ | −1.15 | 598.0 | −90 |
| | 532 | 10RuO₂—90ZrO₂ | 75 | 3.0 × 10⁹ | −3.27 | 1.5 | 150 |
| | 533 | 100ZrO₂ | 100 | 5.8 × 10⁹ | −3.34 | 0.9 | 210 |

In this study, a voltage between an anode and a cathode was fixed to 7 kV. In Table 5, for the power consumption, a total power consumption of a panel in the case where 18 pieces of 110 mm spacers are mounted on a 17-inch panel is shown. Six lines of spacers are formed in the 17 inch panel and three pieces of spacers of 110 mm in length are formed with approximately 15 mm gap being provided therebetween in each line. Accordingly, the number of mounted spacers per panel is 18. If this power consumption is larger than 20 W, it is not preferable because the power consumed in one panel becomes huge. The power consumption is preferably less than 20 W.

Moreover, for the amount of beam deflection, a deviation amount, when an electron beam emitted from an emitter is emitted onto a fluorescent paint on an anode, was quantitatively evaluated using a magnifying glass and the value of the deviation amount was entered on the table. The temperatures of an anode and a cathode at this time were 24° C. and 26° C., respectively, to maintain a fixed condition. The deflection amount was denoted with “+” when a beam is attracted to a spacer side, and denoted with “−” when it is repelled therefrom. If the beam deflection is equal to or less than ±20 μm, human eyes can not observe a black belt caused by this deviation, which is therefore desirable. The amount of beam deflection in an emitter disposed in the first line just proximal to a gate electrode where a spacer is formed was evaluated.

The beam deflection is a phenomenon caused as follows. That is, if the electrical resistance of a spacer is high and the secondary electron emission coefficient is greater than 1 or smaller than 1, positive charges or negative charges are accumulated in the surface of the spacer, and an emission current is attracted by the charges accumulated in this surface if the charges accumulated in this surface are positive charges, and the emission current is repelled if the charges accumulated in this surface are negative charges. As a result, a position deviating from the center of a fluorescent substance on an anode substrate formed right above the emitter is irradiated with an electron beam to thereby cause the beam deflection. If beam deflection occurs, a region where a fluorescent substance does not emit light will occur and thereby a linear black belt will be observed along a spacer, which is therefore not preferable.

In Examples 501 to 503, a thin film of RuO₂ containing TiO₂ was formed. The volume resistivity of the whole spacer was on the order of 10⁶ to 10⁸ Ωcm, and both the power consumption and deflection amount were excellent, and the temperature coefficient of resistance was also improved by approximately 1%/° C. as compared with a glass substrate itself. However, as shown in Comparative Examples 521 to 524, in either case where the content of TiO₂ is too low or where it is too high, the power consumption and the amount of beam deflection become poor, which was therefore not preferable. That is, as shown in Comparative Examples 521 and 522, when the content of TiO₂ is less than 50 mol %, the volume resistivity is extremely small as from 10⁻⁶ to 10⁻¹ Ωcm, so that the power consumption increased too much and the deflection amount also increased in a repelling manner, which was not preferable.

On the other hand, as shown in Comparative Examples 523 and 524, when the content of TiO₂ is equal to or greater than 90 mol %, the spacer resistance increased to on the order of 10⁹ Ωcm and thus the power consumption can be suppressed, however, the surface is charged to positive. and therefore the beam shifted significantly to the attraction side, which was not preferable. Moreover, the absolute value of the temperature coefficient of resistance increased to be almost equal to that of the spacer substrate, so that it was difficult to improve the temperature coefficient of resistance.

Furthermore, as shown in Table 5, when the film composition is expressed in mol %, even if the additive element is Ir, Hf, or Zr, as in the case of addition of Ti, when the content of an added oxide is 60 mol % to 80 mol %, spacers having an appropriate volume resistivity, the spacers being capable of improving the temperature coefficient of resistance, the spacers allowing for appropriate power consumption and deflection amount, could be obtained.

However, when the content of an added oxide is equal to or less than 50 mol %, the volume resistivity decreases too much and the power consumption increases and the amount of beam deflection increases in a repelling manner, which is therefore not preferable. Moreover, when the content of an added oxide exceeds 80 mol %, the volume resistivity of a spacer increases too much, so that an improvement effect of the temperature coefficient of resistance will no longer be seen and the beam will be attracted significantly, which is therefore not preferable.

In this study, paying attention to RuO₂ as an oxide AO_{y} exhibiting metal-like electrical conductivity, a study has been conducted paying attention to a solid solution thin film AₓB₍₁₋ₓ₎O_{y} based oxide that uses a titanium oxide (TiO₂), an iridium oxide (IrO₂), a hafnium oxide (HfO₂), or a zirconium oxide (ZrO₂) as an oxide BO_{y} to be dissolved into AO_{y}, the BO_{y} having a higher resistance than AO_{y}. However, as long as a material can form a solid solution by adding, into an oxide exhibiting metallic electronic conductivity, an oxide having a higher resistance than the former oxide, any material can obtain the effects as described above.

It should be further understood by those skilled in the art that although the foregoing description has been made on embodiments of the invention, the invention is not limited thereto and various changes and modifications may be made without departing from the spirit of the invention and the scope of the appended claims.

### ADVANTAGES OF THE INVENTION

A spacer of the present invention is excellent in voltage endurance. Thus, an abnormal discharge is unlikely to occur even if a high voltage of over 10 kV is applied to between panels, and panel destruction is unlikely to occur. Moreover, since the temperature coefficient of resistance of the spacer is negative and the absolute value thereof is small, the spacer is excellent in effectively suppressing a thermal runaway. Moreover, deflection of an electron beam is unlikely to occur. This allows for a high-definition flat panel display device to be provided.

1. A flat panel display device comprising:
a cathode substrate including an electron source;
an anode substrate including a fluorescent substance which emits light upon receiving electrons emitted from the electron source; and
a spacer disposed between the cathode substrate and the anode substrate and supporting the both substrates,
wherein the spacer comprises, on a surface of a glass substrate, a thin film comprising particles exhibiting metal-like electrical conductivity dispersed in a metal oxide matrix exhibiting semiconductor-like electrical conductivity.

2. The flat panel display device according to claim 1, wherein the substance exhibiting metal-like electrical conductivity comprises at least one kind selected from the group consisting of Au, Pt, Ag, Cr, and Cu.

3. The flat panel display device according to claim 1, wherein the metal oxide exhibiting semiconductor-like electrical conductivity is an oxide selected from the group consisting of Ga₂O₃, Cr₂O₃, Fe₂O₃, and a complex oxide of Fe₂O₃ and Ga₂O₃.

4. The flat panel display device according to claim 1, wherein elements forming the metal oxide exhibiting semiconductor-like electrical conductivity comprise iron and gallium, and contain, in terms of Fe₂O₃ and Ga₂O₃ oxides, from 20% to 80% by mol of Fe₂O₃ and from 80% to 20% by mol of Ga₂O₃.

5. The flat panel display device according to claim 1, wherein a thickness of the thin film is in the range from 20 nm to 200 nm.

6. The flat panel display device according to claim 1, wherein the glass substrate comprises an electronic conducting glass.

7. A flat panel display device comprising:
a cathode substrate including an electron source;
an anode substrate including a fluorescent substance which emits light upon receiving electrons emitted from the electron source; and
a spacer disposed between the cathode substrate and the anode substrate and supporting the both substrates,
wherein the spacer comprises:
a glass substrate;
a first metal oxide thin film exhibiting a semiconductor-like electrical conductivity, the first metal oxide thin film being directly formed on a side surface of the glass substrate;
a second metal oxide thin film into which particles exhibiting metal-like electrical conductivity are dispersed, the second metal oxide thin film being formed on an outside of the first metal oxide thin film; and
a third metal oxide thin film exhibiting semiconductor-like electrical conductivity, the third metal oxide thin film being formed on an outside of the second metal oxide thin film.

8. The flat panel display device according to claim 7, wherein the substance exhibiting metal-like electrical conductivity comprises at least one kind selected from the group consisting of Au, Pt, Ag, Cr, and Cu.

9. The flat panel display device according to claim 7, wherein the metal oxide exhibiting semiconductor-like electrical conductivity is an oxide selected from the group consisting of Ga₂O₃, Cr₂O₃, Fe₂O₃, and a complex oxide of Fe₂O₃ and Ga₂O₃.

10. The flat panel display device according to claim 7, wherein elements forming the metal oxide exhibiting semiconductor-like electrical conductivity comprise iron and gallium, and contain, in terms of Fe₂O₃ and Ga₂O₃ oxides, from 20% to 80% by mol of Fe₂O₃ and from 80% to 20% by mol of Ga₂O₃.

11. The flat panel display device according to claim 7, wherein a thickness of the thin film is in the range from 20 nm to 200 nm.

12. The flat panel display device according to claim 7, wherein the glass substrate comprises an electronic conducting glass.

13. A flat panel display device comprising:
a cathode substrate including an electron source;
an anode substrate including a fluorescent substance which emits light upon receiving electrons emitted from the electron source; and
a spacer disposed between the cathode substrate and the anode substrate and supporting the both substrates,
wherein the spacer comprises a glass substrate and a thin film formed on a side surface thereof,
wherein the thin film comprises: particles exhibiting metal-like electrical conductivity; a metal oxide layer exhibiting an insulator-like electrical characteristic which covers surfaces of the particles; and
a composite metal oxide into which said particles are dispersed, and
wherein the composite metal oxide comprises a solid solution of a metal oxide having semiconductor-like electrical conductivity and a metal oxide having insulator-like electrical conductivity.

14. The flat panel display device according to claim 13, wherein the substance exhibiting metal-like electrical conductivity comprises at least one kind selected from the group consisting of Au, Pt, Ag, Cr, and Cu.

15. The flat panel display device according to claim 13, wherein the metal oxide having semiconductor-like electrical conductivity is an oxide selected from the group consisting of Ga₂O₃, Cr₂O₃, Fe₂O₃, and a complex oxide of Fe₂O₃ and Ga₂O₃.

16. The flat panel display device according to claim 13, wherein elements forming the metal oxide having semiconductor-like electrical conductivity comprise iron and gallium, and contain, in terms of Fe₂O₃ and Ga₂O₃ oxides, from 20% to 80% by mol of Fe₂O₃ and from 80% to 20% by mol of Ga₂O₃.

17. The flat panel display device according to claim 13, wherein a thickness of the thin film sin the range from 20 nm to 200 nm.

18. The flat panel display device according to claim 13, wherein the glass substrate comprises an electronic conducting glass.

19. A flat panel display device comprising:
a cathode substrate including an electron source;
an anode substrate including a fluorescent substance which emits light upon receiving electrons emitted from the electron source; and
a spacer disposed between the cathode substrate and the anode substrate and supporting the both substrates,
wherein the spacer comprises a glass substrate and, on a surface of the glass substrate, an oxide thin film exhibiting metal-like electrical conductivity, and
wherein the oxide thin film is formed of a solid solution composed of an oxide exhibiting metal-like electrical conductivity and an oxide having a higher resistance than the former oxide.

20. The flat panel display device according to claim 19, wherein the oxide exhibiting metal-like electrical conductivity is a ruthenium oxide, and the oxide having a higher resistance than the former oxide comprises at least one kind selected from the group consisting of a titanium oxide, an iridium oxide, a hafnium oxide, and a zirconium oxide.

21. The flat panel display device according to claim 19, wherein the glass substrate comprises an electronic conducting glass.

22. A spacer for a flat panel display device,
wherein the spacer is disposed between a cathode substrate and an anode substrate and supporting the both substrates, wherein the cathode substrate includes an electron source of the flat panel display device, the anode substrate includes a fluorescent substance which emits light upon receiving electrons emitted from the electron source, and wherein a thin film exhibiting semiconductor-like electrical conductivity is formed on a surface of the spacer.

23. The spacer for a flat panel display device according to claim 22, wherein the thin film comprises particles exhibiting metal-like electrical conductivity dispersed in a metal oxide matrix exhibiting semiconductor-like electrical conductivity.

24. The spacer for a flat panel display device according to claim 22, wherein the spacer comprises:
a glass substrate, a surface of which is covered with a thin film;
a first metal oxide thin film exhibiting semiconductor-like electrical conductivity, the first metal oxide thin film being directly formed on a side surface of the glass substrate;
a second metal oxide thin film into which particles exhibiting metal-like electrical conductivity are dispersed, the second metal oxide thin film being formed on an outside of the first metal oxide thin film; and
a third metal oxide thin film exhibiting semiconductor-like electrical conductivity, the third metal oxide thin film being formed on an outside of the second metal oxide thin film.
